(19) United States
(12) Patent Application Publication
(10) Pub. No.: US 2026/0281512 A1
(43) Pub. Date: Sep. 17, 2026

(54) SYSTEM

(71) Applicant: SoftBank Group Corp., Tokyo (JP)

(72) Inventor: Keisuke KAKUDA, Tokyo (JP)

(73) Assignee: SoftBank Group Corp., Tokyo (JP)

(21) Appl. No.: 19/549,040

(22) Filed: Feb. 25, 2026

Related U.S. Application Data
(60) Provisional application No. 63/770,754, filed on Mar. 12, 2025.

(51) Int. Cl. H04N 21/81; G06N 3/0464; G06N 3/0475; G06T 7/20; G06V 10/25; H04N 21/44; H04N 21/442

(52) U.S. Cl. CPC H04N 21/812; G06N 3/0464; G06N 3/0475; G06T 7/20; G06V 10/25; H04N 21/44008; H04N 21/44218; G06V 2201/07

(57) ABSTRACT

A system includes a processor configured to analyze video content on a frame-by-frame basis to evaluate video images and audio, identify scene changes, characters, backgrounds, colors, movements, conversation content, music, and sound effects, and determine scenes and timings suitable for advertisement insertion. Based on the analysis result, the processor generates an advertisement matching a theme of the video content and an interest of a viewer by combining visual and auditory elements. The processor embeds the generated advertisement into a selected scene such that the advertisement is naturally integrated into the video content, including adjusting advertisement visuals to blend with backgrounds or objects and adjusting advertisement audio to match an acoustic environment of the video content.

### CROSS-REFERENCE TO RELATED APPLICATION

This application claims the benefit of U.S. Provisional Application No. 63/770,754 filed on Mar. 12, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional online video distribution platforms commonly present advertisements as pre-roll, mid-roll, or post-roll segments that interrupt playback of video content. Such interruptive advertisements tend to be perceived as intrusive and reduce viewer satisfaction, and they may cause users to skip or block advertisements, thereby diminishing advertising effectiveness. Existing systems that attempt to place advertisements inside video content often rely on static placements or manually prepared product insertions that do not adapt to the actual scene structure, audio context, or individual viewer preferences. As a result, the advertisements are frequently mismatched with the thematic or emotional tone of the current scene, fail to blend naturally with backgrounds or objects in the video, and do not adequately reflect viewers' interests or past behaviors. Furthermore, conventional systems typically do not continuously optimize advertisement content and embedding methods based on feedback data such as viewing time, skip rate, and explicit user responses. Consequently, there is a need for a system that can automatically analyze video content in detail, generate advertisements that are contextually and personally relevant, and embed such advertisements naturally into the video while adaptively improving their presentation over time, thereby reducing perceived ad forcefulness and improving both viewer satisfaction and advertising performance.

### SUMMARY

To solve the above-described problems, the invention provides a system comprising a processor configured to analyze video content, generate advertisements based on analysis results, and embed the generated advertisements naturally into the video content. The processor is configured to analyze video images and audio of video content on a frame-by-frame basis, identify scene changes, characters, backgrounds, colors, movements, conversation contents, music, and sound effects, and determine scenes and timings suitable for insertion of an advertisement. The processor is further configured to generate, based on the analysis result, an advertisement that matches a theme of the video content and an interest of a viewer, the advertisement being created by combining visual elements and auditory elements, and to embed the generated advertisement into a specific scene of the video content such that the advertisement is naturally integrated into the video content by adjusting visuals of the advertisement using video editing techniques so that the visuals blend into backgrounds or objects in the video content and by adjusting audio of the advertisement to match an acoustic environment of the video content. In one aspect, the processor is configured to continuously optimize content and embedding methods of the advertisement based on a viewing history of the video content and feedback from a user, including collecting and analyzing data such as advertisement viewing time, skip rate, and explicit feedback to adjust future advertisement content and timing and to provide different advertising experiences for individual users. In another aspect, the processor is configured to use a generation model trained in advance on a plurality of advertisement datasets to generate advertisements having various styles and contents and to customize the generated advertisements based on a past viewing history and interests of the viewer so that, for example, when the viewer frequently watches sports-related videos, the processor generates advertisements for sporting goods that better match the viewer's interests.

The term “video content” refers to any digital audiovisual work including moving images and associated audio, such as movies, television programs, user-generated videos, live streams, and recorded broadcasts, that is capable of being played back on an electronic device. The term “analysis result” refers to structured data generated by the processor through analysis of video images and audio of video content, the structured data including, for example, identified scene changes, characters, backgrounds, colors, movements, conversation contents, music, sound effects, and candidate scenes and timings suitable for insertion of an advertisement.

The term “scene change” refers to a transition between portions of video content that differ from each other in visual or temporal characteristics, such as cuts, fades, or camera movements, and that are detected by the processor based on changes in image features or motion.

The term “character” refers to a person, animated figure, or other identifiable entity appearing in the video content, which may be recognized by the processor using facial recognition, body detection, or other pattern recognition techniques.

The term “background” refers to visual elements in the video content that are not the primary focus of attention, including scenery, interior or exterior environments, walls, shelves, billboards, posters, and other static or relatively static objects behind or around characters or main actions. The term “movement” refers to temporal changes in position, orientation, or appearance of objects or characters in the video content, including camera motion such as panning, tilting, or zooming, as determined by the processor through motion vector analysis or similar techniques. The term “conversation contents” refers to semantic information derived from speech present in the audio of the video content, including words, phrases, dialogues, and topics obtained through speech recognition and natural language processing.

The term “music” refers to audio components in the video content that comprise melodies, harmonies, rhythms, or other musical elements, whether they are background scores, theme songs, or incidental music.

The term “sound effects” refers to non-musical audio components in the video content that represent environmental sounds, impacts, ambient noises, or artificially produced audio cues intended to enhance or represent actions or events.

The term “advertisement” refers to information content designed to promote or inform about products, services, brands, or other commercial or non-commercial messages, which is generated or selected for presentation to a viewer in association with video content.

The term “visual elements” refers to graphical or pictorial components of an advertisement, including images, text overlays, logos, product renderings, animations, or video clips that are displayable within or over the video content.

The term “auditory elements” refers to audio components of an advertisement, including voiceovers, spoken messages, sound effects, jingles, and background music that are playable through an audio output device.

The term “theme of the video content” refers to a primary subject matter, genre, or contextual category associated with the video content, such as cooking, sports, fashion, travel, or technology, as inferred or determined by the processor from the analysis result.

The term “interest of a viewer” refers to a preference or inclination of an individual viewer toward particular topics, categories, product types, or presentation styles, as estimated by the processor based on viewing history, advertisement interaction data, or explicit user feedback.

The term “specific scene” refers to a defined temporal portion of the video content, bounded by a start time and an end time, within which an advertisement is to be embedded by the processor. The term “naturally integrated” refers to a state in which an advertisement is visually and acoustically embedded in the video content in a manner that maintains or minimally disturbs the continuity, visual coherence, and acoustic balance of the original video scene.

The term “video editing techniques” refers to computational methods for modifying or compositing video images, including color matching, perspective transformation, masking, keying, motion tracking, and blending, used by the processor to adjust how an advertisement appears within the video content.

The term “acoustic environment of the video content” refers to characteristics of the audio portion of the video content at a given time, including loudness, frequency distribution, presence of speech or music, and background noise, which the processor uses to adjust advertisement audio.

The term “viewing history” refers to recorded data indicating which video contents or categories a user has watched, when and how long the user watched them, and how the user interacted with associated advertisements.

The term “feedback from a user” refers to explicit or implicit responses provided by the user regarding advertisements, including, for example, skip actions, like or dislike indications, ratings, comments, or other interaction signals.

The term “skip rate” refers to a measure representing how frequently or how quickly users perform a skipping operation on advertisements, such as the proportion of advertisements skipped or the average time until a skip occurs.

The term “advertisement viewing time” refers to a duration for which an advertisement is displayed or audible to a user during playback of video content, measured, for example, from the start of display or playback until completion or skipping of the advertisement.

The term “different advertising experience for each user” refers to a condition in which content, timing, style, or presentation of advertisements is varied on a per-user basis, so that individual users receive advertisements that are tailored to their respective profiles and behaviors. The term “generation model” refers to a machine learning model, such as a generative neural network, that is trained on advertisement-related data and is configured to produce new advertisement content including visual or auditory elements in response to input conditions or prompts.

The term “advertisement datasets” refers to collections of data relating to advertisements, including images, videos, audio tracks, textual descriptions, metadata, and performance statistics, which are used to train or fine-tune the generation model.

The term “various styles and contents” refers to differing visual designs, narrative tones, lengths, formats, product categories, and message types of advertisements that the generation model is capable of producing.

The term “past viewing history” refers to historical information about which video contents a viewer has previously watched, including categories, durations, timestamps, and associated interaction behaviors.

The term “sporting goods” refers to products, equipment, apparel, or accessories used for sports, fitness, or athletic activities, such as balls, rackets, shoes, clothing, and training devices.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

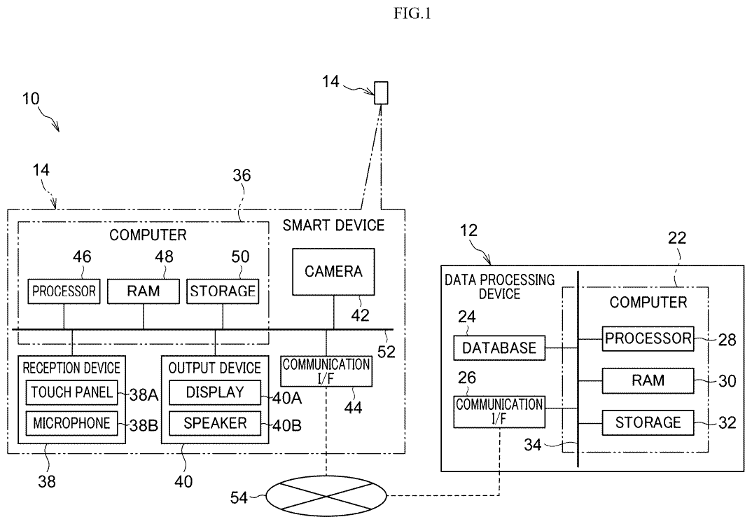

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

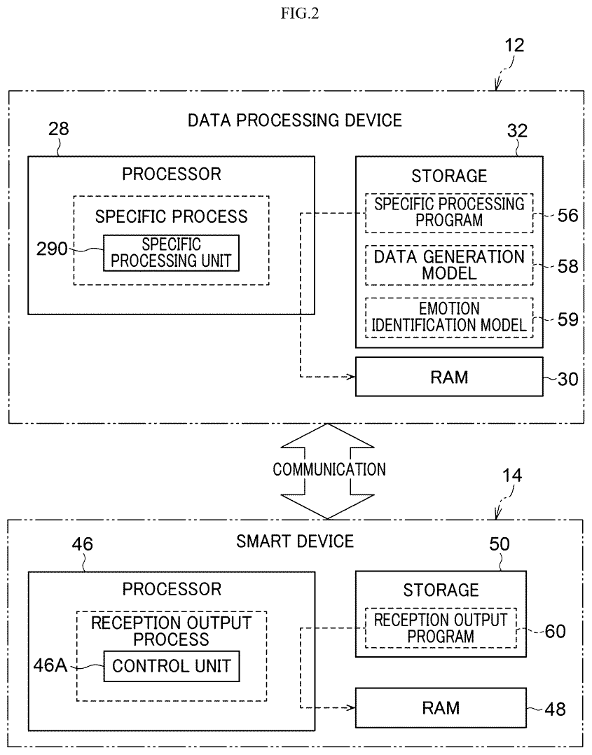

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional advertisement insertion techniques for audiovisual content primarily rely on static rule-based decision logic, pre-produced advertisement assets, and coarse-grained user segmentation. Such techniques typically insert preexisting advertisements at fixed time points (for example, between programs or at simple scene boundaries) without taking into account fine-grained audiovisual features, contextual emotional tone, and detailed user interaction history. As a result, the inserted advertisements often appear intrusive or irrelevant to the current scene or to the particular user, which degrades user experience and reduces advertisement effectiveness. Furthermore, in many existing systems, creative generation of advertisement content is separated from the runtime delivery system and is performed manually or in offline batch workflows. The runtime system merely selects from a fixed library of pre-generated advertisements. This separation prevents the system from dynamically tailoring advertisement content to the specific visual and audio context of each scene and to current user preferences. In addition, known systems do not exploit generative models using prompt sentences constructed from low-level scene analysis, emotional state estimation, and user behavior analytics, and therefore cannot adaptively refine the generation and placement of advertisements based on real-time feedback. From a computer-technology standpoint, current solutions suffer from the following technical limitations:
(1) They do not fully utilize the computing resources of a content distribution infrastructure to perform integrated time-series analysis of multi-modal audiovisual signals and user behavior data, and therefore fail to derive a rich scene representation suitable for precise, context-aware ad placement.
(2) They do not include a feedback loop in which user interaction signals (such as skip operations, view durations, and explicit evaluations) are used to automatically update the rules that construct prompt sentences and the conditions that control ad selection and placement, leading to static and suboptimal behavior over time.
(3) They do not provide a coordinated control flow that jointly orchestrates a generative AI model (for textual, visual, and audio content) and a terminal-side rendering pipeline (for image composition and audio mixing) under unified server-side control. As a result, there is no mechanism to generate, normalize, and embed dynamically created advertisement materials in a manner synchronized with video playback and scene structure.

Consequently, there is a need for an improved computer-implemented system that (i) performs fine-grained analysis of video and audio streams to generate structured scene description information including candidate regions for advertisement placement; (ii) generates prompt sentences, as inputs to a generative AI model, that encode scene features and user features; (iii) uses the outputs of the generative AI model to dynamically create and normalize advertisement materials; (iv) distributes detailed embedding control information to terminal devices for synchronized visual and auditory embedding; and (v) collects user behavior information to continuously update prompt-generation rules, advertisement concept selection conditions, and placement planning conditions. Such a system can improve the functioning of computers in the technical field of multimedia processing and personalized content delivery by enabling more efficient use of processing resources, more accurate content adaptation, and an automated feedback-driven optimization loop.

The specific processing by the specific processing unit 290 of the data processing device 12 in Example 1 is realized by the following means.

The present invention provides a server comprising a processor configured to analyze viewing information including video information and audio information in a time-series manner to generate scene description information including scene types, emotional states, main topics, and advertisement placement candidate regions; to acquire user history information and execute a recommendation process that combines scene feature information and user feature information in order to select advertisement concepts and generate, in a natural language, prompt sentences for a generative information processing model; to input the prompt sentences to the generative information processing model and thereby generate and normalize advertisement materials including character information, image information, and audio information according to predetermined technical constraints; to produce embedding control information specifying temporal and spatial placement and audio mixing parameters for the advertisement materials and to transmit the embedding control information to a terminal device so that the terminal device executes synchronized image composition processing and audio mixing processing; and to collect user behavior information from the terminal device and update prompt-generation rules, advertisement concept selection conditions, and advertisement placement planning conditions based on the collected user behavior information. This enables an integrated computer-implemented pipeline in which multi-modal scene analysis, generative AI-based advertisement creation, and terminal-side embedding are coordinated under server control with a closed-loop feedback mechanism, thereby improving the technical functioning of multimedia delivery systems by reducing intrusive advertisement insertions, increasing contextual relevance, and adaptively optimizing computational resources and content-generation parameters over time.

The term “viewing information” refers to digital information that includes at least video information and audio information and that is processed for presentation to a user by a playback device.

The term “video information” refers to time-series image data representing a sequence of frames or images suitable for visual reproduction on a display device.

The term “audio information” refers to time-series sound data representing voice, music, sound effects, or other acoustic signals suitable for auditory reproduction.

The term “time-series manner” refers to processing that is performed with respect to successive time positions of audiovisual data, such as frame-by-frame or segment-by-segment processing in temporal order.

The term “image features” refers to characteristics of image data, including but not limited to color, brightness, texture, edges, shapes, motion vectors, and spatial arrangements of pixels or regions.

The term “acoustic features” refers to characteristics of audio data, including but not limited to energy, pitch, spectral components, timbre, rhythm, and other parameters derived from an audio waveform or spectrum.

The term “scene boundary” refers to a time position in viewing information at which a change of scene occurs, such as a cut, transition, or substantial change in visual or audio context.

The term “object” refers to an identifiable element within image data, such as a physical item, device, sign, or surface, that can be localized by an object detection process.

The term “subject” refers to a main entity or person appearing in a scene, such as a presenter, actor, or other primary figure that is distinguished from background elements.

The term “background environment” refers to image regions that represent surroundings or context of a scene, including walls, landscapes, buildings, or other non-primary elements. The term “color distribution” refers to a statistical representation of colors present in image data, such as histograms or other measures of the occurrence of color values or ranges.

The term “motion amount” refers to a quantitative measure of movement between frames, such as magnitudes of motion vectors or other indicators of temporal change in image regions. The term “conversation contents” refers to semantic information obtained from spoken language in audio data, such as words, phrases, or sentences recognized by speech recognition and language processing.

The term “music information” refers to information characterizing musical components within audio data, including melody, harmony, rhythm, genre, or presence of background music.

The term “sound effect information” refers to information characterizing non-speech, non-music sounds within audio data, such as environmental effects, impact noises, or synthetic sound cues.

The term “advertisement placement candidate region” refers to a spatial region within video information, such as a signboard, display surface, posting surface, or display device, that is suitable for display of an advertisement.

The term “signboard” refers to an image region representing a board, panel, or similar structure intended for visual display of information or graphics.

The term “display surface” refers to a portion of an image corresponding to a physical or virtual surface on which visual content can be presented, such as a wall section, screen, or panel.

The term “posting surface” refers to an area in image data corresponding to a location where posters, notices, or similar content can be attached or visually represented.

The term “display device” refers to a device represented within the image, such as a monitor, television, or digital signage, that is capable of visually presenting content.

The term “scene description information” refers to structured information associated with a scene, including at least a scene type, an emotional state, a main topic, and advertisement placement candidate regions.

The term “scene type” refers to a classification label that characterizes a scene, such as kitchen, street, office, stadium, or similar environment category.

The term “emotional state” refers to an estimated affective tone or mood of a scene, such as joyful, tense, sad, or neutral, derived from analysis of audiovisual information.

The term “main topic” refers to a principal subject matter or theme of a scene, such as cooking, fashion, technology, sports, or other semantic category.

The term “user identification information” refers to data that identifies or distinguishes a user or user session, such as an identifier, token, or account-related information.

The term “user history information” refers to stored information related to past behavior of a user, including viewing history information, advertisement viewing history information, operation history information, and preference information.

The term “viewing history information” refers to records of content that a user has watched or accessed, including identifiers, timestamps, duration, or categories of viewed items.

The term “advertisement viewing history information” refers to records of advertisements presented to a user, including advertisement identifiers, display times, durations, and outcomes such as completion or skipping.

The term “operation history information” refers to logs of user interactions with a playback or interface system, including play, pause, skip, click, or other control operations.

The term “preference information” refers to explicit or implicit indicators of user likes, dislikes, or interests, such as preferred categories, rated content, or inferred preferences from behavior.

The term “scene feature information” refers to data describing characteristics of a scene, derived from scene description information, used as input to a recommendation process.

The term “user feature information” refers to data describing characteristics of a user, derived from user history information, used as input to a recommendation process.

The term “recommendation process” refers to computational processing that selects or ranks items, such as advertisement types or concepts, based on input features including scene feature information and user feature information.

The term “advertisement type” refers to a classification of an advertisement, such as product category, service category, or format category, used to select or generate advertisement content.

The term “advertisement concept” refers to an abstract representation of an advertisement idea, including a target product or service, message, and intended style or theme.

The term “prompt sentence” refers to a natural-language textual input that encodes scene description information, user feature information, and an advertisement concept, and that is supplied to a generative information processing model.

The term “generative information processing model” refers to an information processing model, such as a generative AI model, that generates new information, including text, images, or audio, in response to input data such as a prompt sentence.

The term “advertisement materials” refers to digital content elements used to form an advertisement, including advertisement character information, advertisement image information, and advertisement audio information.

The term “advertisement character information” refers to textual components of an advertisement, such as slogans, descriptions, scripts, or captions.

The term “advertisement image information” refers to visual components of an advertisement, such as images, frames, graphics, or visual layouts.

The term “advertisement audio information” refers to auditory components of an advertisement, such as narration, music, or sound effects.

The term “predetermined conditions” refers to technical constraints or specifications applied to advertisement materials, including at least length, resolution, format, and content-related requirements.

The term “normalize” refers to processing that adjusts data or content to conform to specified technical conditions or standard formats, such as resizing, re-encoding, or level adjustment.

The term “advertisement placement planning information” refers to information defining how and where advertisement materials are to be placed in viewing information, including temporal and spatial positions and related parameters.

The term “temporal position” refers to a time-related coordinate, such as a start time or end time, specifying when an advertisement material is to be presented in relation to viewing information.

The term “spatial position” refers to a location within image data, such as coordinates or regions, specifying where an advertisement material is to be displayed.

The term “embedding control information” refers to information used to control embedding of advertisement materials, including start time, end time, display position, display region, display order, and mixing conditions.

The term “display position” refers to a position on a display surface or screen at which an advertisement material is rendered.

The term “display region” refers to an area of a display or image within which an advertisement material is displayed.

The term “display order” refers to a relative ordering or layering of visual elements, including advertisement materials and original content, for rendering.

The term “mixing conditions” refers to parameters controlling combination of audio signals or visual layers, such as volume levels, blending modes, or transparency.

The term “terminal device” refers to an end-user device that reproduces viewing information and displays or plays embedded advertisement materials, such as a smartphone, tablet, computer, or television device.

The term “image composition processing” refers to processing that combines multiple image or video layers into a single output for display, including operations such as overlaying, blending, or transforming visual elements.

The term “audio mixing processing” refers to processing that combines multiple audio signals into a single output signal, adjusting levels, timing, and other properties.

The term “user behavior information” refers to data representing actions or responses of a user in relation to advertisements or content, including advertisement viewing time, advertisement skip operations, advertisement selection operations, evaluation operations, and other user actions. The term “advertisement viewing time” refers to a duration during which a user is exposed to or plays back an advertisement material.

The term “advertisement skip operation” refers to a user-initiated action that causes playback of an advertisement to be shortened, bypassed, or terminated.

The term “advertisement selection operation” refers to a user action indicating interest in an advertisement, such as clicking or tapping an advertisement region or a related control.

The term “evaluation operation” refers to a user action that provides feedback on an advertisement, such as rating, liking, disliking, or otherwise assessing the advertisement.

The term “prompt-generation rules” refers to rules or parameters used to construct prompt sentences, including selection of content elements, wording, and constraints.

The term “advertisement concept selection conditions” refers to criteria or parameters used to select an advertisement concept based on scene feature information and user feature information.

The term “advertisement placement planning conditions” refers to criteria or parameters used to determine placement of advertisements, including timing, region selection, and alignment with scene structure.

The term “language model” refers to a model that processes or generates natural-language text, such as advertisement character information, based on input data including prompt sentences.

The term “image generation model” refers to a model that generates image data, such as advertisement image information, based on input data including prompt sentences or condition information.

The term “video generation model” refers to a model that generates video data, such as animated or moving advertisement image information, based on input data including prompt sentences or condition information.

The term “common condition information” refers to information shared among multiple models, such as scene type information, emotional state information, user preference information, and advertisement placement candidate region information, and used as conditions for generating mutually consistent outputs.

The term “user preference information” refers to data representing likes, dislikes, or interests of a user, derived from explicit input or inferred from behavior, and used as part of common condition information.

The term “generative AI model” refers to an implementation of a generative information processing model realized using artificial intelligence techniques that can generate new content, such as text, images, or audio, in response to prompt sentences.

In one embodiment, a server, a plurality of terminals, and a communication network together implement the claimed system. The server includes at least one processor, a memory, a nonvolatile storage device, and a network interface. The terminal includes at least one processor, a graphics processing unit (GPU) or graphics accelerator, a display, an audio output unit, a user input unit, and a network interface. The server and the terminal execute software modules that implement the functions described below.

The server executes an operating system such as a general-purpose server operating system and runs middleware components including a web server, an application server, and a database management system. The server stores video information and audio information in a storage device such as a solid-state drive. The server executes an image processing library such as a generic frame-decoding library and a numerical computation framework such as a generic tensor computation library. The server uses these software components to decode compressed video streams into raw frames, to decode compressed audio streams into audio waveforms, and to store intermediate results in memory.

The server uses a neural network architecture implemented with a deep learning framework to extract image features and acoustic features. In one embodiment, the server employs a convolutional neural network (CNN) for image feature extraction, an optical flow estimation algorithm for motion estimation, and a transformer-based model for audio transcription and natural language processing. The CNN receives, as input, pixel values of each frame represented in a standardized format such as RGB 8-bit at a normalized resolution. The CNN computes feature maps at multiple layers by applying convolution, non-linear activation, and pooling operations. The server computes color distributions from these feature maps by aggregating channel statistics, and the server computes edge and texture descriptors using gradient-based filters.

The server computes motion amounts by applying an optical flow algorithm between consecutive frames. For example, the server computes dense motion vectors using a gradient-based method or a neural-network-based flow estimator. The server then calculates a magnitude distribution of the motion vectors and determines scene boundaries when the magnitude distribution or the color distribution changes beyond a predefined or learned threshold. The server thereby identifies scene boundaries more precisely than simple time-based rules and avoids redundant processing of frames belonging to the same scene.

The server uses an object detection model, such as a region-based convolutional model or a one-stage detector, to detect objects and advertisement placement candidate regions within each frame. The model outputs bounding boxes, class labels, and confidence scores for objects such as signboards, display devices, walls, posters, and other surfaces that can serve as display surfaces. The server treats bounding boxes that correspond to such surfaces as advertisement placement candidate regions and stores their coordinates as structured data, for example as tuples (scene_id, x1, y1, x2, y2, region_type).

The server performs face detection and subject identification using a face recognition model that transforms detected face regions into embeddings in a vector space and groups them by similarity. The server thereby identifies main subjects in the scene and distinguishes them from background elements. The server also determines background environments by analyzing object categories and spatial layouts, for example classifying a scene as a kitchen, a street, or an office. The server extracts the audio track and converts it into a waveform at a standard sampling rate. The server sends the waveform to an automatic speech recognition (ASR) model implemented as a deep neural network, such as a sequence-to-sequence model with attention or a transformer-based model. The ASR model outputs a sequence of tokens and associated timestamps representing the recognized spoken words. The server then applies a language model to the sequence of tokens to generate a cleaned transcript.

The server applies a natural language processing pipeline that includes a topic classification model and a sentiment analysis model. The topic classification model can be a transformer-based classifier that maps the transcript segments into fixed-length embeddings and outputs topic labels such as cooking, fashion, technology, or sports. The sentiment analysis model outputs an emotional state label such as joyful, tense, or neutral for each transcript segment. The server aligns the transcript segments with scene boundaries by comparing timestamps and associates each scene with a main topic and an emotional state.

The server aggregates the above-described results into scene description information. For each scene, the server creates a record containing at least a scene identifier, a scene type, an emotional state, a main topic, a list of detected objects, a list of advertisement placement candidate regions (with coordinates and region types), and temporal information such as start and end times. The server stores this scene description information in a database in the form of relational tables or key-value documents. This explicit data structure enables efficient querying when the server later selects advertisement concepts or generates embedding control information.

The server acquires user history information by querying a user data store using user identification information that the terminal transmits at the start of a session. The user history information contains viewing history information, advertisement viewing history information, operation history information, and preference information. The server converts this information into user feature information represented as numerical feature vectors. For example, the server includes features such as counts of content viewed in each category, average watch duration, frequency of skipping advertisements, and inferred preference scores for categories. The server executes a recommendation process by inputting both scene feature information and user feature information to a ranking model. The ranking model can be implemented as a gradient-boosted decision tree model or a neural network. In one embodiment, the neural network includes an input layer that receives the concatenated scene and user feature vectors, several fully connected layers with non-linear activation, and an output layer that produces scores for multiple advertisement types or advertisement concepts. The server selects an advertisement concept having the highest score or a score exceeding a threshold. This selection is performed independently for each scene, thereby allowing scene-specific advertisement generation. The server generates a prompt sentence for a generative AI model based on the scene description information, user feature information, and the selected advertisement concept. The server uses a set of prompt-generation rules stored as templates and parameter mappings. For example, a template may specify that the prompt sentence should include the scene type, emotional state, main topic, user preference indicators, and a product description. The server fills in the template with concrete values from the scene and user data to produce a natural-language string. Examples of such prompt sentences include:

“Generate a 10-second video ad for a non-stick frying pan that matches a joyful home-cooking scene in a bright kitchen, targeting home chefs who enjoy easy and healthy cooking.” “Create a static image ad for urban sneakers with bold colors and a dynamic street background, suitable for insertion on a city billboard in a high-energy fashion vlog.”

“Generate a banner-style ad and short tagline for a new Android smartphone, emphasizing camera quality and battery life, to be placed on a virtual screen behind a tech reviewer in a calm, informative scene.”

“Produce a 10-second cooking-related ad introducing high-quality olive oil, matching a relaxed dinner preparation scene and using soft, warm lighting and a gentle, inviting tone in the narration”

The server inputs the prompt sentence to a generative AI model serving infrastructure. In one embodiment, the generative AI model includes a language model that generates advertisement character information and an image generation model that generates advertisement image information. The language model can be a transformer-based generative model trained on a large text corpus including advertisement texts. The model receives the prompt sentence as a sequence of tokens and outputs a sequence of tokens representing advertisement slogans, description texts, and narration scripts. The image generation model can be a diffusion-based model that generates images conditioned on textual prompts. The server passes the same prompt sentence, or a derived prompt with additional visual guidance, to the image generation model to obtain one or more high-resolution images.

The server, when necessary, uses a video generation model that extends the diffusion-based approach to the temporal dimension or uses an image sequence synthesis technique to generate short video clips. The server specifies parameters such as resolution, frame rate, and clip length as part of the model input. The server thereby generates advertisement image information or video information that is aligned with the advertisement character information.

The server converts the advertisement character information into advertisement audio information by using a text-to-speech (TTS) model. The TTS model can be a neural vocoder combined with a sequence-to-sequence text-to-spectrogram model. The server adjusts prosody parameters such as speaking rate, pitch, and energy based on the emotional state stored in the scene description information. For example, in a joyful scene, the server sets a slightly higher pitch and faster rate to match the scene tone.

The server normalizes the generated advertisement materials by converting image resolutions, aspect ratios, audio sampling rates, and codecs to predetermined formats compatible with the terminals. For example, the server resizes images to specific pixel dimensions, converts images into a compressed format, encodes audio into a compressed audio format, and limits the duration of narration according to system constraints. The server checks for compliance with content rules by applying content filters or classifiers that detect prohibited terms or unsafe imagery.

The server generates advertisement placement planning information by combining the scene description information and the normalized advertisement materials. The server selects specific advertisement placement candidate regions based on criteria such as size, visibility, and absence of occluding objects. The server determines temporal positions for insertion by aligning with scene boundaries and avoiding conflict with important dialogue as indicated by the transcript. The server then creates embedding control information for each advertisement material including start time, end time, display position (e.g., coordinates in normalized screen space), display region dimensions, display order (layer index relative to original video layers and other overlays), and mixing conditions such as alpha blending coefficients and audio volume levels. The server transmits the advertisement materials and the embedding control information to the terminal via the network interface using a communication protocol. The server can send the base video or a reference to a video stream along with a structured message that encodes all embedding instructions. By precomputing detailed embedding control information, the server reduces processing load on the terminal and ensures that terminals with different hardware capabilities can still perform consistent embedding using their local graphics and audio subsystems.

The terminal receives the base video, the advertisement materials, and the embedding control information. The terminal stores these data in a local memory or storage device. The terminal then reproduces the base video on the display using a media playback framework. The terminal uses a graphics processing unit or graphics accelerator and a graphics API such as a generic 2D/3D drawing library to render the base video frames and overlay the advertisement materials onto the appropriate regions. The terminal maps the coordinates received from the server to display coordinates, applies perspective transformations when the advertisement placement candidate region is not aligned with the screen axes, and performs blending operations using alpha transparency values. The terminal thereby combines original frames and advertisement layers in real time.

The terminal reproduces audio by mixing the base audio and the advertisement audio. The terminal uses an audio mixing engine to control volume levels and pan parameters. Based on the mixing conditions included in the embedding control information, the terminal reduces the base background music volume when the advertisement narration starts and restores it after the narration ends. The terminal keeps the timing of advertisement audio synchronized with the corresponding visual insertion period by referencing the playback position of the base video. The terminal provides a user interface for the user to view the video and interact with advertisements. The terminal displays playback controls and may present interactive elements such as skip buttons or detail buttons overlaid near the advertisement region or in a control area. The user can operate a touch screen, keyboard, or remote controller to perform operations including skipping advertisements, selecting advertisements for more information, or providing rating feedback.

The terminal records user behavior information such as advertisement viewing time, skip operations, selection operations, and evaluation operations. The terminal timestamps these events and associates them with advertisement identifiers and scene identifiers. To reduce communication load, the terminal batches these event records and transmits them periodically to the server. The terminal may apply simple local filtering or aggregation, such as counting repeated identical events within a short period, to reduce redundant transmissions. The server receives the user behavior information and stores it in a behavior log database. The server analyzes the behavior logs to compute metrics, such as skip rates and completion rates, for each type of prompt sentence, advertisement concept, and placement pattern. The server uses these metrics to update the prompt-generation rules, the advertisement concept selection conditions, and the advertisement placement planning conditions. For example, if advertisements generated from certain prompt templates consistently exhibit high skip rates, the server reduces the weight of such templates or modifies them to shorten the target duration or decrease perceived intrusiveness by changing wording regarding animation intensity or information density.

The server also retrains or fine-tunes the recommendation model and the generative models. The server uses a supervised learning procedure in which user engagement metrics act as target signals. For the recommendation model, the server feeds training samples consisting of scene feature information, user feature information, and labels derived from observed user behavior such as “engaged” or “skipped.” The server defines a loss function, such as cross-entropy or a ranking loss, and updates model weights using gradient-based optimization. For the generative AI model, the server may adjust parameters of prompt templates or update fine-tuning layers to better align generated outputs with user preferences.

By implementing this closed-loop update process, the server does not merely automate a human workflow; instead, the server optimizes internal data structures and model parameters to improve computational efficiency and content relevance. For example, by predicting which scenes are unlikely to yield effective advertisements for a given user, the server can avoid generating advertisement materials for those scenes, thereby reducing the number of calls to generative models and lowering processing load and network traffic. The server can also compress scene description information and embedding control information using tailored encodings so that the terminal receives only necessary parameters, which further decreases communication bandwidth requirements.

The described system provides technical advantages over conventional rule-based or pre-baked advertisement insertion. The fine-grained scene analysis utilizing CNN-based image features, optical-flow-based motion estimation, and transformer-based language analysis enables the server to delineate scene boundaries and emotional states with greater accuracy, reducing misaligned or jarring advertisement insertions. The use of structured scene description information and user feature information as inputs to the recommendation model enables the server to compute high-dimensional similarity relationships that are difficult for human operators to handle, thus improving matching accuracy and reducing trial-and-error.

Because the server determines advertisement placement candidate regions based on detected objects and surfaces, and because the terminal uses GPU-based compositing with explicit embedding control information, the system achieves stable real-time rendering performance. The advertised image is embedded as a texture on a detected region, using perspective and color adjustments that the server and terminal coordinate through quantitative parameters instead of manual design. This provides a computer-technical improvement in the way display hardware is controlled to present composite video content.

In alternative embodiments, the server may use different neural network architectures. For example, the server may employ a three-dimensional convolutional network for joint spatiotemporal feature extraction, or a bidirectional recurrent network for modeling audio context. The generative AI model may be composed of multiple sub-models, where a first model generates a high-level storyboard and a second model generates final images and text. The server can also switch between multiple prompt-generation strategies, such as using shorter prompts when latency constraints are strict, thereby dynamically controlling the trade-off between generation quality and processing time.

In another embodiment, the terminal may perform a subset of the scene analysis locally, for example detecting advertisement placement candidate regions on-device, while the server focuses on generative processing and optimization over many users. In yet another embodiment, the system may operate on live-streamed content, where the server processes a sliding window of video and audio, generates advertisements and embedding control information in near real time, and pushes updates to the terminal. These variations demonstrate that the described techniques are not limited to a specific content type or hardware platform but instead contribute to improved operation of multimedia processing and generative content systems across configurations.

Through the combination of multi-modal scene analysis, structured prompt sentence generation, coordinated generative AI processing, and terminal-side compositing under detailed server control, the system improves the functioning of computers in handling complex audiovisual streams and in delivering personalized, context-aware advertisements with reduced computational overhead and improved accuracy.

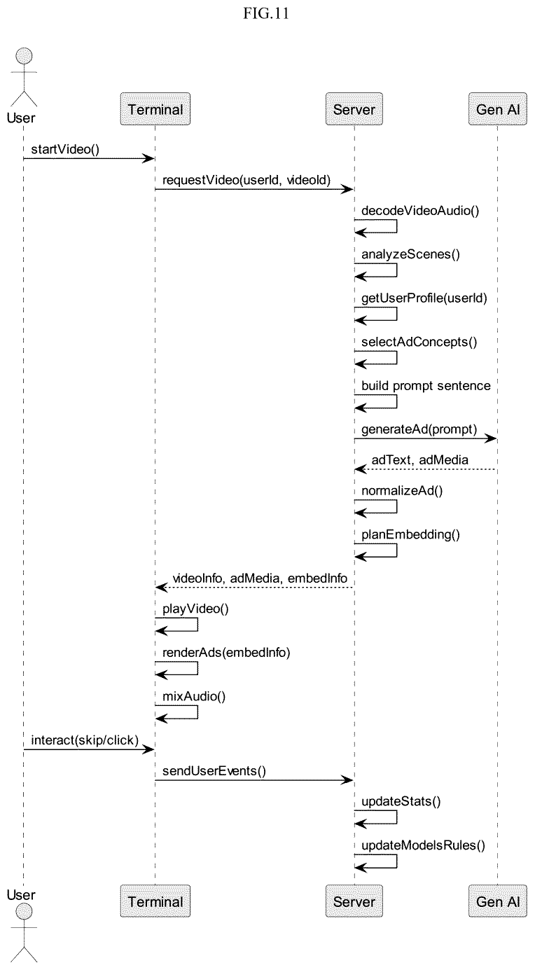

The following describes the processing flow using FIG. 11.

### Step 1:

Server receives, as input, compressed viewing information including a video stream, an audio stream, and associated identifiers from a content distribution platform via a network interface. Server writes the compressed streams to a storage device and invokes a decoding library to convert the compressed video into a sequence of raw frames and the compressed audio into a raw waveform. Server outputs decoded video frames indexed by frame number and timestamp, and decoded audio samples indexed by sample index and timestamp. Server thereby converts encoded multimedia data into a normalized internal representation that is suitable for subsequent feature extraction.

### Step 2:

Server receives, as input, the decoded video frames from Step 1.

Server applies a convolutional neural network to each frame to compute image features, including intermediate feature maps, color distributions, and edge and texture descriptors. Server also applies an optical flow algorithm between consecutive frames to compute motion vectors and motion amounts. Server compares the distributions of image features and motion amounts across time and detects scene boundaries when differences exceed a threshold. Server outputs, for each scene, a list of frame indices, start and end timestamps, and aggregated visual feature vectors. Server thus transforms per-frame pixel data into scene-level visual feature information.

### Step 3:

Server receives, as input, the decoded audio waveform from Step 1.

Server segments the waveform into overlapping time windows and feeds the segments into an automatic speech recognition model to obtain text tokens and timestamps. Server aligns the recognized tokens to generate a time-stamped transcript. Server then feeds transcript segments into a topic classifier and a sentiment classifier implemented as neural networks to compute probabilities for topics (for example, cooking, fashion, technology) and emotional states (for example, joyful, tense, neutral). Server outputs a transcript with per-segment topic labels and emotional state labels, each associated with start and end timestamps. Server thereby converts raw audio samples into structured linguistic and emotional information.

### Step 4:

Server receives, as input, the per-scene visual feature information from Step 2 and the time-stamped transcript information from Step 3.

Server aligns transcript segments with scenes by matching timestamps and aggregates for each scene the dominant topic, the dominant emotional state, and key phrases recognized from the transcript. Server also applies an object detection network to selected frames within each scene to detect objects such as signboards, display devices, walls, or posters, and records bounding boxes and object types as advertisement placement candidate regions. Server compiles, for each scene, scene description information containing scene type, emotional state, main topic, detected objects, candidate regions, and temporal boundaries. Server outputs a structured scene description list for the entire video. Server thus converts multi-modal input (visual and audio) into a unified scene description data structure.

### Step 5:

Server receives, as input, a user identifier or session token from Terminal when the user starts or resumes viewing.

Server queries a user data store using the identifier and retrieves viewing history information, advertisement viewing history information, operation history information, and stored preference information. Server transforms these records into numerical user feature vectors by computing feature values such as category viewing frequencies, average ad completion rates, skip frequencies, and inferred preference scores. Server outputs a user feature vector associated with the current session and caches it in memory. Server thereby converts historical user activity data into a machine-readable user profile representation.

### Step 6:

Server receives, as input, the scene description list from Step 4 and the user feature vector from Step 5.

Server iterates over each scene and concatenates scene feature information (for example, topic, emotional state, region statistics) with user feature information to form a joint feature vector. Server inputs this vector into a recommendation model to compute scores for multiple advertisement types and concepts. Server selects, for each scene, one or more advertisement concepts with the highest scores or above a threshold, and records for each selected scene a target advertisement concept and a desired duration or format. Server outputs a mapping from scene identifiers to selected advertisement concepts and target properties. Server thus transforms combined scene and user features into concrete advertisement planning decisions.

### Step 7:

Server receives, as input, the scene description information and the selected advertisement concepts from Step 6.

Server generates, for each selected scene, a prompt sentence in natural language by filling a template with scene attributes (scene type, emotional state, main topic), user preference indicators from the user feature vector, and the chosen advertisement concept. For example, when the scene type is a bright kitchen, the emotional state is joyful, and the concept is a non-stick frying pan, Server constructs the prompt sentence:

“Generate a 10-second video ad for a non-stick frying pan that matches a joyful home-cooking scene in a bright kitchen, targeting home chefs who enjoy easy and healthy cooking.” Server similarly constructs other prompt sentences, such as:

“Create a static image ad for urban sneakers with bold colors and a dynamic street background, suitable for insertion on a city billboard in a high-energy fashion vlog.”

“Generate a banner-style ad and short tagline for a new Android smartphone, emphasizing camera quality and battery life, to be placed on a virtual screen behind a tech reviewer in a calm, informative scene.”

“Produce a 10-second cooking-related ad introducing high-quality olive oil, matching a relaxed dinner preparation scene and using soft, warm lighting and a gentle, inviting tone in the narration.”

Server outputs a list of prompt sentences, each linked to a scene identifier and an advertisement concept. Server thus transforms structured numerical features into human-readable instructions for a generative AI model.

### Step 8:

Server receives, as input, the list of prompt sentences from Step 7.

Server sends each prompt sentence, with generation parameters such as maximum length, style constraints, and resolution requirements, to a generative AI model that includes at least a language model and an image or video generation model. The language model generates advertisement character information such as slogans, descriptions, and narration scripts in response to the prompt sentence. The image or video generation model generates advertisement image information or short video clips conditioned on the same or a related prompt. Server collects the generated texts and visual assets and associates them with their originating prompt and scene identifier. Server outputs preliminary advertisement materials, including raw text, images, and optional video segments. Server thereby transforms textual prompt sentences into new multimedia advertising content.

### Step 9:

Server receives, as input, the preliminary advertisement materials from Step 8.

Server filters and normalizes these materials according to predetermined technical constraints. Server checks that the text does not contain prohibited content and that the image or video resolutions and aspect ratios match target display requirements. Server resizes images or video frames, re-encodes them into target formats, and trims or pads their durations. Server converts advertisement character information to advertisement audio information by applying text-to-speech synthesis, generating audio waveforms that respect specified duration and emotional tone inferred from the scene. Server adjusts loudness levels and sampling rates to standard values. Server outputs normalized advertisement materials ready for embedding, including final image or video files and audio files with metadata describing their properties. Server thus converts unconstrained generative outputs into technically compliant advertisement assets.

### Step 10:

Server receives, as input, the normalized advertisement materials from Step 9 and the scene description information from Step 4.

Server determines, for each advertisement material, a temporal position and one or more advertisement placement candidate regions within the associated scene. Server selects candidate regions based on size, visibility, and relevance (for example, preferring signboards or display devices detected near the main subject). Server calculates spatial coordinates, scaling factors, and optional perspective transforms for each placement, and assigns a display order relative to the base video and other overlays. Server assigns audio mixing parameters, such as initial volume and ducking levels for background audio, based on the scene's existing sound profile. Server compiles embedding control information that includes, for each advertisement material, start time, end time, display position, display region size, layer order, and mixing conditions. Server outputs an embedding control data structure and associates it with the corresponding advertisement materials and base video segments. Server thus converts high-level placement decisions into explicit control parameters for terminal-side rendering.

### Step 11:

Server receives, as input, the base video or a reference to the video, the normalized advertisement materials, and the embedding control information from Step 10.

Server packages these elements into one or more messages suitable for transmission to Terminal, where each message includes identifiers, resource locations, and control parameters. Server transmits the package via a network interface using a communication protocol that may include compression or chunking to reduce bandwidth usage and latency. Server outputs network messages that reach Terminal and instruct Terminal how and when to render each advertisement material. Server thereby converts internal data structures into a transmitted representation usable by distributed client devices.

### Step 12:

Terminal receives, as input, the network messages from Server containing the base video reference, advertisement materials, and embedding control information.

Terminal stores the received advertisement images, video clips, and audio files in local storage and registers the embedding control information in memory for real-time access during playback. Terminal initiates video playback of the base content using a local media framework, which decodes video frames and audio samples. Terminal outputs rendered video frames and audio to its internal processing pipeline, preparing them for subsequent overlay operations. Terminal thus converts received encoded streams and assets into a local playback state.

### Step 13:

Terminal receives, as input, the current playback time and the embedding control information from Step 12.

Terminal checks, at each rendering interval, which advertisement materials should be active based on the current playback time and the start and end times defined in the embedding control information. For each active advertisement material, Terminal calculates its display position and size in screen coordinates, applies any perspective or affine transformations, and issues drawing commands to its graphics subsystem to overlay the advertisement image or video frame onto the base video frame. Terminal uses blending parameters, such as alpha values, to combine pixels from the advertisement and the base video. Terminal outputs composited frames to the display hardware, presenting a seamless combination of original content and embedded advertisements. Terminal thereby converts timing and positional control parameters into concrete rendering operations on a display.

### Step 14:

Terminal receives, as input, the base audio stream and the advertisement audio streams associated with currently active advertisements, as well as audio mixing conditions from the embedding control information.

Terminal feeds these audio signals into an audio mixer and adjusts individual channel gains according to mixing conditions, for example lowering background music volume when advertisement narration starts and restoring it afterward. Terminal ensures synchronization between advertisement audio playback and visual embedding by aligning playback positions to the base video's time reference. Terminal outputs a mixed audio signal to the audio output unit (such as speakers or headphones). Terminal thus transforms multiple audio sources and control parameters into a synchronized, perceptually balanced audio output.

### Step 15:

User receives, as input, the composited video frames and mixed audio produced by Terminal in Steps 13 and 14.

User views the embedded advertisements as part of the video content and may interact with control elements shown on the screen, such as skip buttons or detail buttons. User operations, such as touching or clicking these controls or selecting the advertisement area itself, generate user input events. User thereby provides implicit and explicit feedback about the relevance and acceptability of the advertisements.

### Step 16:

Terminal receives, as input, user input events generated by User during playback. Terminal logs information about each event, including event type (for example, skip, click, rating), timestamp, associated advertisement identifier, and scene identifier. Terminal measures advertisement viewing time by tracking when each advertisement becomes active and when it is skipped or ends. Terminal accumulates these records in a local buffer or lightweight database. Terminal outputs batched user behavior information, formatted for transmission, and periodically sends the batches to Server. Terminal thus converts raw user interactions into structured user behavior data.

### Step 17:

Server receives, as input, the user behavior information from Terminal in Step 16. Server writes these records to a behavior log and joins them with existing records that link each advertisement material to its originating prompt sentence, advertisement concept, and embedding parameters. Server computes aggregate metrics, such as skip rate per prompt template, click-through rate per advertisement concept, and completion rate per placement pattern. Server analyzes these metrics to detect patterns, such as specific prompt sentence structures that consistently produce low engagement or particular placement regions that lead to high skip rates. Server outputs updated statistics and adjustment signals for prompt-generation rules, advertisement concept selection conditions, and advertisement placement planning conditions. Server thereby converts raw behavioral events into feedback signals that guide future system behavior.

### Step 18:

Server receives, as input, the adjustment signals and updated statistics from Step 17. Server updates internal configuration data for prompt-generation templates, modifying elements such as typical advertisement lengths, preferred expression styles, and instructions regarding intrusiveness in prompt sentences. Server also retrains or fine-tunes the recommendation model using new training data derived from user behavior, updating model weights to favor advertisements and placements that historically achieved higher engagement. Server stores new model parameters and configuration profiles in persistent storage. Server outputs updated prompt-generation rules, recommendation model parameters, and placement rules that will be used in future executions of Steps 6 through 10. Server thus converts empirical performance data into changes in model and rule parameters, improving accuracy and efficiency of subsequent advertisement generation and embedding.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional advertising systems embedded in multimedia environments, including virtual spaces and time-series contents, typically rely on static targeting rules and pre-authored creatives. In many cases, a server merely selects one advertisement from a fixed inventory on the basis of coarse attributes such as content category or user demographic information, and a terminal simply displays the selected advertisement at predetermined positions or times. Such architectures suffer from several technical limitations.

First, these systems do not fully exploit fine-grained user interaction signals, such as real-time gaze trajectories, dwell times on specific objects, or detailed operation histories in a virtual scene. As a result, the server cannot construct a high-resolution model of user interest fields or attention patterns, and cannot adapt advertisement content or placement at the temporal and spatial granularity required for immersive environments. This leads to a mismatch between what the user is actually focusing on within a rendered scene and where or how the advertisement is rendered.

Second, existing systems that use machine learning or content analysis often treat the advertisement creative as a fixed artifact generated offline. Even when a generative AI model is introduced, the model is frequently invoked with static or manually defined prompt sentences that are not systematically updated on the basis of measured advertisement performance. Consequently, the system cannot close the feedback loop between low-level behavior signals (e.g., gaze-based attention, view time, skip operations) and the generative AI model's input conditions, and therefore cannot continuously improve the relevance and effectiveness of generated advertisement expressions.

Third, immersive or virtual environments impose additional technical constraints on latency, rendering, and ergonomic placement of visual and audio elements. When advertisement placement logic is not tightly coupled with the virtual space coordinate system and the user's position and gaze direction, the system may consume processing resources to render advertisements that appear outside the effective field of view, or at locations that cause visual clutter or discomfort. This degrades system efficiency and user experience, and in some cases can increase processing load on the rendering pipeline without corresponding benefit. Accordingly, there is a need for an improved computer-implemented system in which a processor dynamically analyzes interaction-level user behavior in a virtual or multimedia environment, automatically constructs and updates prompt sentences for a generative AI model on the basis of such analysis and feedback, and controls both the generation and spatial/temporal embedding of advertisement information. Such a system should technically improve the use of computational resources by displaying only contextually relevant advertisements in regions of likely user attention, reduce unnecessary data transmission and rendering operations, and provide a closed-loop optimization mechanism that enhances the quality and adaptability of generative advertisement content at runtime.

The specific processing by the specific processing unit 290 of the data processing device 12 in Application Example 1 is realized by the following means.

The present invention provides a server comprising at least one processor and at least one memory storing instructions which, when executed by the at least one processor, cause the at least one processor to analyze information content and user behavior information to generate analysis results; to generate, on the basis of the analysis results and the user behavior information, a prompt sentence to be input to a generative AI model and to generate advertisement information by using the generative AI model in accordance with the prompt sentence; to embed or place the generated advertisement information into at least one of a virtual space or a time-series content by controlling a layout, a visual appearance, or an audio parameter in accordance with at least one of user position information, gaze-direction information, or interest-field information; to acquire, as user behavior information, at least gaze information, operation information, and browsing-history information of a user, and to provide the user behavior information to at least one of an analysis unit or a generation unit including the generative AI model; and to optimize at least one of the prompt sentence or generation conditions of the advertisement information on the basis of an evaluation result derived from at least one of a user attention state, an advertisement viewing time, or an operation history with respect to the embedded or placed advertisement information. This enables a computer-implemented advertising system in which the generative AI model is tightly integrated into a closed-loop pipeline that uses fine-grained interaction data to adapt prompt sentences, dynamically controls the spatial and temporal embedding of advertisement information within a rendered environment, reduces unnecessary rendering and transmission of low-relevance advertisements, and thereby improves the technical functioning of both server-side processing and client-side presentation in immersive or multimedia contexts.

The term “information content” refers to any digital content processed by the system, including but not limited to visual data, audio data, time-series media data, and interaction logs presented to or generated by a user.

The term “analysis unit” refers to hardware, software, or a combination thereof that processes information content and user behavior information to extract features, compute statistics, or derive analysis results used for advertisement generation and placement.

The term “user behavior information” refers to data representing actions or states of a user in relation to the information content or virtual space, including at least gaze information, operation information, and browsing-history information.

The term “gaze information” refers to data indicating a direction, target, or duration of a user's line of sight within a display area or virtual space, obtained by an eye-tracking device, sensor, or software estimator.

The term “operation information” refers to data indicating explicit user inputs, including but not limited to button presses, selection operations, navigation operations, and interaction events with displayed elements or objects.

The term “browsing-history information” refers to data indicating sequences and durations of content or object views by a user, including visited regions, viewed items, and timestamps associated with such views.

The term “analysis results” refers to processed data derived from the analysis unit, including but not limited to detected objects, inferred user interests, attention patterns, or contextual attributes used as a basis for advertisement generation.

The term “generative AI model” refers to a machine-implemented model, such as a neural network trained on data sets, that produces new content, including text, images, audio, or other media, based on input conditions or prompt sentences.

The term “prompt sentence” refers to a structured natural-language or machine-interpretable instruction provided as input to the generative AI model, specifying constraints, style, content focus, or other conditions for generating advertisement information.

The term “advertisement information” refers to data defining an advertisement, including at least text, images, audio, video, layout parameters, or metadata used for presenting promotional content to a user.

The term “generation unit” refers to hardware, software, or a combination thereof that constructs prompt sentences, invokes the generative AI model, and produces advertisement information in response to analysis results and user behavior information.

The term “embedding unit” refers to hardware, software, or a combination thereof that determines spatial, temporal, and presentation parameters for placing advertisement information into a virtual space or time-series content.

The term “virtual space” refers to a computer-generated three-dimensional or two-dimensional environment in which objects, items, and user viewpoints are defined in a coordinate system and rendered for display.

The term “time-series content” refers to content that evolves over time, including but not limited to video streams, audio streams, animations, or interactive sequences with an ordered temporal structure.

The term “layout” refers to spatial arrangement parameters of advertisement information, including position, size, orientation, and relative placement with respect to other objects or display regions.

The term “visual appearance” refers to graphical attributes of advertisement information, including color, brightness, texture, transparency, animation, and styling settings used in rendering.

The term “audio parameter” refers to sound-related attributes associated with advertisement information, including volume, frequency characteristics, spatialization, timing, and mixing with other audio signals.

The term “acquisition unit” refers to hardware, software, or a combination thereof that collects user behavior information, such as gaze information, operation information, and browsing-history information, from sensors, input devices, or logs.

The term “optimization unit” refers to hardware, software, or a combination thereof that evaluates advertisement performance based on user behavior information and updates prompt sentences or generation conditions to improve subsequent advertisement information.

The term “user attention state” refers to an inferred condition indicating a level or focus of user attention, estimated from signals such as gaze fixation, dwell time, and interaction frequency with displayed elements.

The term “advertisement viewing time” refers to a duration during which advertisement information is within a user's effective field of view or is considered to be attended to by the user.

The term “operation history” refers to a chronologically ordered set of operation information entries indicating how a user has interacted with content or advertisement information over time. The term “stay-time information” refers to data indicating a duration for which a user remains within a specific region of a virtual space or remains focused on a particular item or display target.

The term “gaze-tracking information” refers to sequences of gaze information over time, indicating how the user's line of sight moves across objects or regions in a display or virtual space.

The term “selection-operation information” refers to operation information that specifically indicates user selections, such as choosing an item, opening details, saving an offer, or skipping an advertisement.

The term “item information” refers to data describing an object or entity presented in the virtual space or content, including attributes such as category, identifier, descriptive text, and associated media.

The term “display-target information” refers to data describing an element that can be presented on a display, including items, panels, scenes, or regions that may be associated with advertisement information.

The term “interest-field information” refers to data indicating categories, topics, objects, or regions toward which a user has inferred interest, derived from aggregated user behavior information.

The term “position information” refers to data indicating a spatial location of a user, viewpoint, or object within a coordinate system of the virtual space or display environment.

The term “gaze-direction information” refers to data indicating a direction vector or orientation corresponding to where the user is looking within the virtual space or display.

The term “advertisement expression mode” refers to a style or format in which advertisement information is presented, including factors such as text length, visual emphasis, level of detail, and narrative tone.

The term “advertisement viewing-time information” refers to processed metrics derived from advertisement viewing time, including averages, distributions, and statistics used for performance evaluation.

The term “skip-rate information” refers to data indicating a frequency or proportion of skip operations performed by users with respect to displayed advertisement information.

The term “preferred-style information” refers to data indicating a user's preference for particular advertisement expression modes, inferred from user behavior, feedback, or historical performance metrics.

The term “input and output conditions of the generative AI model” refers to parameters and constraints controlling how the generative AI model receives input, such as prompt sentences and context data, and how it produces output, such as format, length, and style of advertisement information.

In one embodiment, a server, a terminal, and a communication network cooperate to implement the system according to the claims. The server comprises at least one processor, at least one memory, non-transitory storage, and network interfaces. The terminal comprises at least one processor, at least one memory, a display device such as a head-mounted display or flat panel display, one or more user input devices such as a controller or pointing device, and, optionally, an eye-tracking sensor. The network is realized by wired or wireless communication, such as a local area network, a wide area network, or a mobile communication network.

The server executes a server-side program stored in the memory. The server-side program is implemented, for example, using a general-purpose operating system and application frameworks, and is configured to realize an analysis unit, a generation unit including a generative AI model, an embedding unit, an acquisition unit, and an optimization unit as functional modules. The server uses a relational database system, such as a general-purpose structured query language database, or a document-oriented database, to persistently store user behavior information, content metadata, advertisement information, and learned parameters for models used by the analysis unit and optimization unit. The server further uses a file storage system or object storage system to store media files such as images, video sequences, and audio data associated with advertisement information.

The terminal executes a terminal-side program stored in the memory. The terminal-side program is implemented, for example, using a real-time rendering engine, such as a three-dimensional graphics engine, and a platform-specific input/output framework. The terminal-side program is configured to render a virtual space, to present time-series content, to obtain sensor data such as head orientation and gaze direction, and to transmit user behavior information to the server. The terminal also receives advertisement information and placement instructions from the server, and renders advertisement information at designated positions and timing within the virtual space or time-series content.

The server implements the analysis unit as a software module that reads user behavior information and content metadata from the storage and performs numerical computation. The analysis unit uses, for example, a numerical computation library and a data frame library to process large volumes of log records efficiently. The server represents user behavior information as structured records, each record including at least a user identifier, a session identifier, a timestamp, a type of event, target identifiers such as item identifiers or display-target identifiers, gaze coordinates or gaze-direction vectors, stay-time values, and operation types such as “open detail,” “add to cart,” “skip advertisement,” or “save offer.” The server organizes these records into time-ordered sequences, grouped by user and session, and computes aggregate statistics such as total stay-time per item, number of views per item, number of operations per advertisement, and sequences of gaze transitions between objects.

The server uses these aggregates as feature vectors. The server defines, for each user and each session, a feature vector that contains, for example: normalized stay-time for each category of items, counts of interactions for each advertisement type, average gaze fixation duration for items in different regions of the virtual space, and frequency of transitions between specific categories. The analysis unit applies clustering or classification algorithms, such as k-means clustering or logistic regression, to these feature vectors to estimate interest-field information for each user. The interest-field information comprises scores per category, scores per brand, and scores for particular display regions in the virtual space.

In one embodiment, the server further uses a neural network model in the analysis unit to predict interest-field information. The server uses, for example, a feed-forward neural network with an input layer corresponding to the user behavior feature vector, one or more hidden layers with rectified linear unit activation functions, and an output layer producing a probability distribution over item categories and advertisement styles. The server trains this neural network offline using historical user behavior information and ground-truth interest labels obtained from long-term engagement statistics. The server uses a cross-entropy loss function and mini-batch gradient descent with back-propagation to update the weights of the neural network. The server optionally employs regularization techniques, such as dropout or weight decay, to improve generalization. The server implements the generation unit as a software module that constructs prompt sentences and invokes a generative AI model. The generative AI model is realized as a neural network, such as a transformer-based sequence model, that has been trained on large amounts of text or multi-modal data including advertisement copy, product descriptions, and user interaction narratives. The server maintains generation parameters, such as temperature, maximum token length, and top-k or nucleus sampling parameters, to control diversity and determinism of the generated text.

The server constructs a prompt sentence by combining content metadata, user interest-field information, and system constraints. The server uses a prompt template that includes placeholders for category labels, feature descriptions, promotion information, and style constraints. The server fills in the placeholders with specific data. Examples of such prompt sentences include:

“Generate an engaging advertisement for running shoes that match this user's strong interest in high-performance sports gear. Use a friendly tone and mention comfort, durability, and a limited-time discount. Focus on the following products: lightweight running shoes with responsive cushioning and breathable upper materials.”

“Generate an advertisement for the latest tent models related to the tents this user has frequently viewed. Emphasize lightweight design, quick setup, and weather resistance. Include a short call to action for a weekend camping sale.”

“Generate a concise, image-focused advertisement for running shoes for a user who quickly skips long text. Use a very short headline and two brief benefit phrases, and avoid long paragraphs.” The server passes the constructed prompt sentence as input to the generative AI model. The server obtains, as output, one or more candidate advertisement texts including headline text, body text, and call-to-action phrases. The server may request the generative AI model to output structured text, for example by instructing it to generate multiple lines with specific roles (headline, subheadline, bullet points). The server parses the generated text accordingly. In another embodiment, the server also uses a generative AI model for visual media. The server constructs a prompt sentence for an image generation model, for example:

“Generate a high-resolution promotional image showing a pair of lightweight running shoes on a running track at sunset. The style should be realistic and energetic.”

“Generate an image of a modern camping tent set up in a forest at dusk, highlighting spacious interior and weather resistance.”

The server sends these prompt sentences to the image generation model and receives generated images. The server resizes the images and converts them into appropriate formats using an image processing library. The server stores the processed images in a media repository and associates them with advertisement identifiers.

The server implements the embedding unit as a software module that determines spatial and temporal placement of advertisement information. The server maintains, for each virtual space, a map between logical regions (for example, “running shoes shelf,” “outdoor equipment section”) and coordinate ranges. The terminal periodically sends user position information and gaze-direction information to the server. The server uses these data, together with interest-field information, to select an advertisement and to compute one or more candidate placement positions, such as a region at the periphery of the user's current field of view or adjacent to a currently viewed item. The server specifies placement parameters, such as three-dimensional coordinates, panel size, orientation, and layering order, and sends these parameters to the terminal along with advertisement information.

The terminal receives these parameters and uses a rendering engine to construct corresponding graphical objects, such as panels or billboards. The terminal maps the advertisement images onto these panels as textures and renders the text using a text rendering subsystem. The terminal can further control audio playback of advertisement narration, for example by starting audio playback when the advertisement enters the user's field of view and stopping or decreasing volume when the user looks away. By coordinating placement with the virtual space coordinate system and user gaze, the system reduces unnecessary rendering of off-screen or low-relevance advertisements, thereby improving rendering performance and reducing processing load on the terminal.

The server implements the acquisition unit as a software module that accepts user behavior information from the terminal via network communication. The terminal samples gaze information from the eye-tracking sensor at a predetermined frequency, for example at 60 Hz, and converts raw sensor data into gaze-direction vectors relative to the virtual camera. The terminal also monitors input devices and generates event records for interactions such as selecting an item, opening details, skipping an advertisement, or saving an offer. The terminal aggregates these samples into compact representations, for example by grouping gaze samples into clusters corresponding to fixation points and sampling interaction events at a coarser time resolution. The terminal transmits these compact representations to the server to reduce bandwidth consumption. The server parses incoming data and stores the records in a time-series structure with indexing on user identifier and timestamp, enabling efficient retrieval and aggregation.

The server implements the optimization unit as a software module that evaluates advertisement performance and adapts both selection logic and prompt sentence generation. The optimization unit defines advertisement performance metrics, such as average advertisement viewing time, skip rate, save rate, and transition probability from advertisement view to item detail view. The server computes these metrics from user behavior information. The optimization unit then updates control parameters used by the analysis unit and generation unit.

For example, the server maintains, for each user, a profile of preferred advertisement expression modes, including a score for concise visual advertisements, a score for detailed textual descriptions, and a score for comparative advertisements. The optimization unit increments or decrements these scores on the basis of observed behavior: if the user frequently skips long texts but spends sufficient time viewing image-centric advertisements, the server raises the score for concise visual advertisements and lowers the score for detailed textual descriptions. The generation unit reads these scores and updates the prompt templates accordingly, such that subsequent prompt sentences request an appropriate style from the generative AI model. The optimization unit can also use reinforcement-learning-style updates or bandit algorithms to choose among multiple prompt templates. The server may treat each template as an arm in a multi-armed bandit and use observed click-through or engagement to update estimated rewards. The server then selects future templates using an algorithm such as upper confidence bound or epsilon-greedy selection. This algorithmic framework allows the system to discover and exploit effective prompt sentence patterns that are not evident a priori.

In one embodiment, the server uses an additional neural network in the optimization unit to map user behavior sequences to prompt parameter configurations, such as length, tone, and emphasis on specific features. The server encodes user behavior sequences as vectors using sequence models, such as recurrent neural networks or transformer encoders. The server trains this network on historical data pairs consisting of behavior sequences, prompt parameters, and subsequent performance metrics. The server defines an objective function that favors prompt parameters leading to high performance metrics, and updates network weights using gradient-based optimization.

Through these mechanisms, the system does more than merely automate human advertisement selection or copywriting. The server leverages fine-grained, high-frequency behavioral signals that cannot be feasibly processed by human operators in real time, and uses these signals to change the internal control parameters of generative and analytic models. The result is an improvement in how the computer allocates computational and rendering resources: the server selects only relevant advertisements and adapts placement to likely attention regions, which reduces unnecessary network transmission and drawing operations. The server further improves the quality of generated content by continuously adjusting prompt sentences and generative parameters according to machine-calculated performance measures, thereby improving precision of targeting and effectiveness of communication.

In another embodiment, the server is configured to operate with different types of terminals. For a non-immersive terminal such as a standard personal computer with a two-dimensional display, the terminal still obtains cursor position, scroll position, and window focus status as substitutes or supplements for gaze information. The server treats these signals similarly in the analysis unit, aggregating dwell times in specific areas of the display. The embedding unit then places advertisements in designated regions of the display, such as side panels or in-line insertion points in a time-series content playback window.

In yet another embodiment, the generative AI model is deployed locally on the server infrastructure, and the server maintains a model storage unit containing trained weights. The server can update the generative AI model periodically by re-training or fine-tuning on new datasets that include successful advertisement texts and user reaction data. The server controls learning rate schedules, batch sizes, and optimization algorithms such as adaptive moment estimation, and uses validation sets to monitor and prevent overfitting. The server may also employ data augmentation techniques, such as paraphrasing, synonym replacement, or controlled noise injection into prompt sentences, to increase robustness of the generative AI model. The described system thus supports multiple concrete implementations while sharing core functional characteristics. The server analyzes content and user behavior, constructs and refines prompt sentences, invokes a generative AI model with controlled parameters, and determines where and how advertisements are embedded in rendered environments. The terminal captures and transmits fine-grained behavior signals and renders advertisement information in synchronization with the virtual space or time-series content. The user naturally interacts with the content and advertisements, and the system continuously transforms those interactions into updated model inputs and control states.

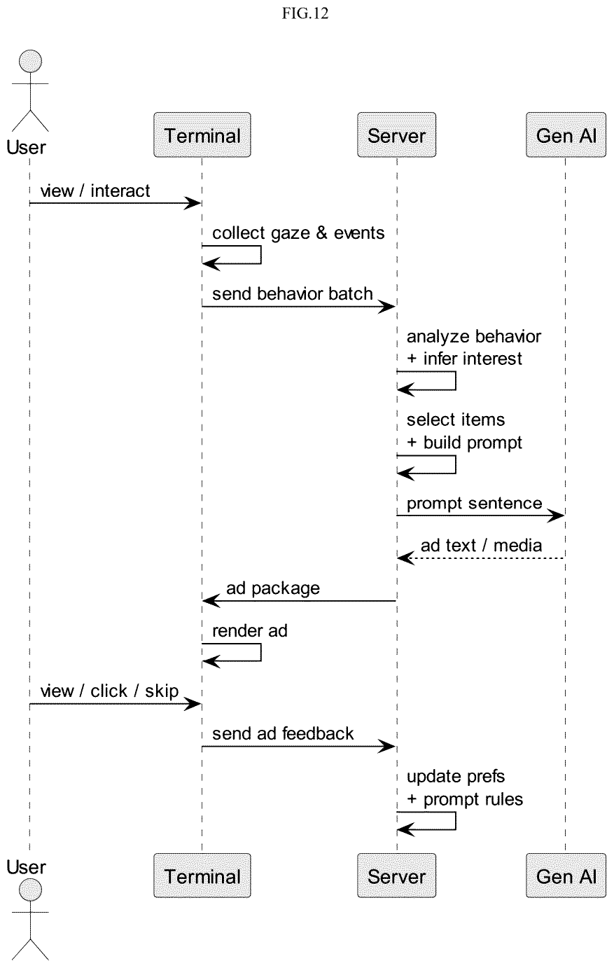

Because the server organizes behavior data into specific data structures, uses defined machine-learning architectures and loss functions, implements explicit algorithms for feature aggregation and prompt selection, and coordinates these modules with terminal rendering control, the invention provides a technical solution that enhances computational efficiency, improves accuracy of interest estimation and advertisement placement, and reduces network and rendering overhead, beyond a mere automation of human decision-making or business practice. The following describes the processing flow using FIG. 12.

### Step 1:

The terminal initializes a virtual environment and input devices.

The terminal loads scene data, object meshes, and texture resources from local storage into a rendering engine. The terminal initializes a display device and associates a virtual camera with a head-mounted display or monitor. The terminal activates input devices, including controllers, keyboard, mouse, and optionally an eye-tracking sensor, and registers event callbacks. Input: configuration data of the virtual space, asset files, hardware status.

Output: an initialized runtime environment including a rendered initial scene and active input streams.

### Step 2:

The user starts viewing and interacting with content.

The user moves within the virtual space, looks at different objects, and performs operations such as pointing, selecting, or opening details.

The terminal updates the virtual camera position and orientation based on head tracking and controller movements, and renders updated frames to the display.

Input: sensor readings (head pose, controller pose), user input signals (button presses, pointing). Output: rendered frames on the display and a continuous stream of raw interaction events.

### Step 3:

The terminal captures user behavior and converts it into structured logs.

The terminal queries the eye-tracking sensor to obtain gaze direction vectors and maps them to hit objects in the scene using ray casting or viewport mapping. The terminal determines which item or display target is under the user's gaze or within the field of view. The terminal records events including timestamps, item identifiers, advertisement identifiers, gaze fixation durations, and operation types such as “open detail” or “skip ad.”

Input: raw gaze coordinates, head pose, scene graph, input events.

Output: structured behavior logs composed of records that include user identifier, session identifier, timestamp, event type, target identifiers, and quantitative values such as dwell time and gaze duration.

### Step 4:

The terminal aggregates behavior logs into compact batches and transmits them to the server. The terminal groups behavior records over a short time window and compresses or summarizes them, for example by accumulating dwell time for each item and merging repeated events. The terminal serializes the batch into a predefined data structure and sends it to the server using a network protocol.

Input: raw behavior log entries collected in memory.

Output: batched behavior data transmitted to the server and acknowledged by a server response.

### Step 5:

The server receives behavior batches and stores them in a persistent data store.

The server validates incoming data, checks authentication and integrity, and parses the serialized format into internal objects. The server writes records to a database table indexed by user identifier and timestamp. The server optionally stores raw and aggregated variants to support later analysis.

Input: batched behavior data from the terminal.

Output: persisted behavior records accessible to analysis and optimization modules.

### Step 6:

The server aggregates behavior data per user and per session.

The server retrieves behavior records for a given user and groups them by session identifier. The server computes statistics such as total dwell time per item, count of detail-view operations, count of add-to-cart operations, and distribution of gaze fixations across categories or regions. The server constructs a feature vector that encodes these statistics for each session. Input: stored behavior records from the database for a target user or session.

Output: session-level feature vectors representing the user's observed behavior.

### Step 7:

The server infers user interest fields from the aggregated features.

The server inputs the session-level feature vectors into an analysis algorithm, such as a clustering model or a neural network classifier. The server calculates category scores and brand scores by applying learned weights to the feature values. If a neural network is used, the server performs a forward pass through input, hidden, and output layers, applying non-linear activation functions to transform the feature vector into a probability distribution over categories, brands, and advertisement styles.

Input: session-level feature vectors.

Output: interest-field information containing ranked categories, brands, and preferred advertisement styles for the user.

### Step 8:

The server selects candidate items and advertisement targets based on interest-field information. The server queries a product or content database using the high-scoring categories and brands as filters. The server retrieves metadata such as item identifiers, category labels, textual descriptions, images, and promotional flags. The server applies ranking rules or scoring functions that take into account interest scores, recency, and promotional priorities, and selects a limited set of candidate items for advertisement.

Input: interest-field information and product metadata.

Output: a candidate set of items and associated attributes for advertisement generation.

### Step 9:

The server constructs a prompt sentence for a generative AI model.

The server loads a prompt template suitable for the user's preferred advertisement style, as indicated by the interest-field information and historical performance. The server fills placeholders with concrete data such as item category, key features, and promotion details. The server may append style constraints, such as “short text,” “detailed comparison,” or “visual focus,” based on prior optimization results.

Input: candidate item set, interest-field information, style preferences, and prompt templates. Output: a fully instantiated prompt sentence that encodes content, focus, and style instructions for the generative AI model.

### Step 10:

The server invokes the generative AI model with the constructed prompt sentence and obtains generated text.

The server sends the prompt sentence to a language generative AI model, along with control parameters such as temperature and maximum output length. The server receives generated sequences that constitute advertisement text, including a headline, body text, and a call to action. The server may request multiple variants to support later selection or testing.

Input: prompt sentence and generation control parameters.

Output: generated advertisement text variants produced by the generative AI model.

### Step 11:

The server optionally generates visual media for the advertisement.

The server derives additional prompt sentences for an image or multi-modal generative AI model by injecting visual cues and desired composition into a visual template. The server sends these prompt sentences to the visual generative AI model and obtains synthesized images. The server then processes these images, for example by resizing, cropping, and compressing them, and stores them in a media repository with references linked to advertisement identifiers. Input: advertisement concept derived from generated text, visual prompt templates, and item attributes.

Output: processed visual media files associated with corresponding advertisement records.

### Step 12:

The server assembles an advertisement package with placement constraints.

The server combines the generated text, associated images or other media, and structural metadata into a single advertisement object. The server adds placement rules indicating in which content regions or virtual space areas the advertisement is eligible to appear, and under which user interest conditions. The server defines parameters such as target category, minimum interest score threshold, and allowed display positions relative to items.

Input: generated text variants, visual media, and contextual constraints.

Output: an advertisement package describing content, assets, and targeting rules.

### Step 13:

The server determines a specific advertisement to send to the terminal in response to a context request.

The terminal periodically or on demand sends a context request describing the user's current position, current gaze direction, and currently viewed items. The server receives this context information and selects an advertisement from the available packages whose targeting rules match the current context and the user's interest-field information. The server prioritizes advertisements based on predicted effectiveness and recency.

Input: context information from the terminal and stored advertisement packages.

Output: a selected advertisement package and associated placement parameters for the current context.

### Step 14:

The terminal receives the advertisement package and prepares rendering resources.

The terminal parses the advertisement package, downloads referenced images or media if not already cached, and maps advertisement elements to rendering objects. The terminal creates or updates user interface components such as panels, billboards, or overlay regions and binds text and images to these components.

Input: advertisement package and media asset references from the server.

Output: ready-to-render advertisement objects integrated into the current scene graph or user interface hierarchy.

### Step 15:

The terminal places and renders the advertisement according to placement parameters and user gaze.

The terminal positions advertisement panels at specified coordinates or relative to target items, adjusts size and orientation based on current camera parameters, and renders them in the display frame. The terminal monitors gaze direction and interaction focus, enlarging or revealing additional text when the user's gaze remains on the advertisement for longer than a threshold. The terminal can also start or stop audio playback associated with the advertisement depending on visibility and focus.

Input: placement parameters, user position and gaze information, and advertisement rendering objects.

Output: visually and optionally audibly presented advertisements aligned with the user's current view.

### Step 16:

The user interacts with the displayed advertisements.

The user can perform explicit actions such as selecting “view details,” “save offer,” or “skip ad” using available input devices. The terminal captures these actions as discrete events associated with the relevant advertisement identifier and time of occurrence.

Input: user actions performed through controllers, touch, or other input devices. Output: interaction event records tied to specific advertisements and timestamps.

### Step 17:

The terminal logs advertisement exposure and interaction metrics for feedback.

The terminal measures the duration that each advertisement remains in the user's field of view and the time between initial exposure and interaction events. The terminal records metrics such as view time, gaze fixation time, skip operations, and selection operations. The terminal aggregates these metrics into feedback records and prepares them for transmission to the server. Input: advertisement display timeline, gaze tracking data, and interaction events. Output: feedback logs containing performance metrics for each advertisement instance.

### Step 18:

The terminal transmits feedback logs to the server for optimization.

The terminal batches the feedback records and sends them to the server using a network protocol. The terminal may compress or otherwise optimize data volume to reduce communication overhead. The server receives and stores these logs in a dedicated analytics data store.

Input: aggregated feedback logs from the terminal.

Output: persisted feedback data available to the server's optimization unit.

### Step 19:

The server evaluates advertisement performance and updates user-specific preferences. The server analyzes the feedback data to compute metrics such as average viewing time, skip rate, and conversion to item detail views. The server updates user preference parameters for advertisement styles by increasing or decreasing scores based on observed engagement for each style. These updated parameters become part of the interest-field information and are stored in the user profile.

Input: feedback logs and existing user preference parameters.

Output: revised user preference parameters and updated interest-field information.

### Step 20:

The server adjusts prompt sentence generation and selection strategies using optimization results. The server modifies prompt templates by adding or removing style constraints and by changing instructions such as “detailed comparison,” “short headline,” or “bullet points.” The server updates internal mappings from user preference parameters to template choices and to generative AI model parameters such as temperature and length constraints. When constructing future prompt sentences, the server uses the updated mapping so that prompt sentences more accurately reflect the user's observed preferences and improve the effectiveness of generated advertisements.

Input: optimization results, updated user preferences, and existing prompt templates. Output: revised prompt templates and generation rules that influence subsequent prompt sentence construction and generative AI model invocation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional advertising presentation systems that insert advertisements into video streams generally select and place advertisement content based on static metadata such as content genre, coarse-grained scene type, or historical viewing behavior. In many such systems, a server-side program analyzes video only at a superficial level and then inserts pre-produced advertisements at fixed insertion points, such as the beginning, middle, or end of a program. These approaches suffer from several technical limitations in terms of computer technology. First, existing systems typically do not perform fine-grained, scene-level analysis of both video and audio signals to generate structured analysis metadata enriched with emotional atmosphere information. As a result, the processing pipeline in such systems cannot utilize detailed scene attributes, such as per-scene motion features, background types, and acoustic cues, to guide the generation and placement of advertisements. This leads to ad insertion logic that is coarse, rigid, and difficult to adapt algorithmically to complex audiovisual content.

Second, conventional systems either ignore the real-time emotional state of the viewer or treat user feedback only as coarse historical statistics, such as total skip counts or click-through counts. These systems do not continuously estimate a user's emotional state in real time by integrating multimodal sensor data from a user terminal, including facial imagery, voice signals, and interaction events, with the current playback time of the video. Without such real-time, time-stamped emotional state information, the server cannot computationally control the timing, position, and visual/audio parameters of advertisement embedding in a way that is responsive to the viewer's current state. This results in intrusive or poorly aligned ad experiences that degrade user engagement and system performance.

Third, while generative models are known in isolation, many existing advertising platforms employ them in a static or loosely coupled manner, such as by offline generation of ad creatives or generic text content. They do not introduce a systematic prompt sentence generation mechanism that translates structured scene metadata, emotional atmosphere, and user emotional state into well-formed natural-language instructions for a generative AI model. Consequently, the generative model is underutilized as a computing component: it is not tightly integrated into the core control loop of the system, and it cannot dynamically generate ad content that is parametrically conditioned on precise context features derived from ongoing computation over video, audio, and user state.

Fourth, even when machine learning is employed for personalization, conventional systems mostly adjust high-level targeting rules or selection among pre-existing ads. They generally do not implement a learning loop that feeds back detailed, time-aligned emotional-state information and interaction-level feedback to update both the prompt generation logic and the parameters of a generative AI model. This means that the ad-generation pipeline, including prompt construction and model behavior, does not improve in a data-driven manner toward better alignment with system-level objectives such as reduction of user discomfort and increase of engagement under various content and user states.

These limitations collectively result in computation pipelines that are inflexible, poorly adaptive, and inefficient in exploiting multimodal signals. The lack of coordinated use of scene-level analysis metadata, real-time user emotional state estimation, prompt sentence generation for generative AI models, and learning-based updates of both prompts and models restricts the technical performance of the overall system, including latency, resource usage, and quality of ad placement as measured by user interaction metrics and emotional responses.

Accordingly, there is a need for an improved advertising presentation system and method that (i) performs detailed video and audio analysis to obtain structured scene-level analysis metadata with emotional atmosphere, (ii) estimates and tracks a user's emotional state in real time at the terminal using multimodal sensing and local inference, (iii) uses such information to automatically construct prompt sentences for a generative AI model that dynamically generates advertisement content adapted to the scene context and user emotional state, and (iv) employs feedback data, including emotional-state information and user interactions, to update the prompt generation logic and model parameters. By addressing these issues, the system can improve the technical operation of the computing environment, including more efficient use of generative models, more context-aware control of rendering and mixing pipelines, and algorithmic improvement of the entire ad-generation and embedding workflow.

The specific processing by the specific processing unit 290 of the data processing device 12 in Example 2 is realized by the following means.

The present invention provides a server comprising a processor configured to analyze video information and audio information of an audiovisual medium on a time-unit basis to divide the audiovisual medium into a plurality of scenes, to generate analysis metadata for each of the plurality of scenes including at least a scene section, a scene type, a background type, a motion feature, and an acoustic feature, and to estimate an emotional atmosphere of each scene based on at least the audio information and the acoustic feature so as to store the emotional atmosphere as part of the analysis metadata; a processor configured to receive, via a communication interface, imaging information, acoustic information, and operation history information transmitted from a terminal, to estimate a temporal transition of an emotional state of a user of the terminal by executing an emotional-state estimation process based on at least the imaging information, the acoustic information, and the operation history information, and to manage emotional-state information in which the emotional state is associated with time information of the audiovisual medium; a processor configured to automatically construct, based on at least the analysis metadata, the emotional-state information, and viewing history information, a prompt sentence in a natural language that serves as an instruction sentence for a generative AI model, to input the prompt sentence as a parameter to the generative AI model, and to obtain advertisement content generated by the generative AI model, the advertisement content including at least advertisement text information and advertisement image information, and to further generate advertisement audio information by applying speech synthesis to at least part of the advertisement text information; a processor configured to compute, based on object-region information and background-region information included in the analysis metadata and dimension information of the advertisement image information, embedding control information including at least an advertisement embedding region, a display position, a display size, and a display time band in the audiovisual medium, and audio control information including at least a start time, a volume coefficient, and a fade time for mixing the advertisement audio information with the audio information of the audiovisual medium, and to transmit the embedding control information and the audio control information to the terminal so that the terminal superimposes the advertisement image information on a corresponding region of the audiovisual medium by projection transformation and composition processing and mixes the advertisement audio information with the audio information of the audiovisual medium in synchronization with reproduction time; and a processor configured to receive, from the terminal, feedback information including at least one of a viewing completion rate, a skip operation, a selection operation, an evaluation input, and emotional-state information during a period in which the advertisement content is presented, to perform analysis processing on the feedback information in association with the analysis metadata and the emotional-state information, and to perform learning-based updating of at least one of a generation rule used to construct the prompt sentence and a parameter of the generative AI model based on a result of the analysis processing. This enables the computing system to algorithmically integrate scene-level analysis metadata, real-time user emotional-state estimation, prompt-based control of a generative AI model, and feedback-driven model and logic updating so as to dynamically generate, place, and render advertisement content in a manner that improves the technical performance of content analysis, generative inference, and media rendering pipelines, thereby reducing intrusive ad behavior, improving resource usage, and enhancing responsiveness and adaptability of the advertising presentation process from the perspective of computer technology.

The term “audiovisual medium” refers to digital content including at least video information and audio information that are temporally synchronized and are reproduced in time sequence on a display device and an acoustic output device.

The term “video information” refers to a sequence of image frames or image data representing visual content of the audiovisual medium.

The term “audio information” refers to an audio track or audio signal associated with the audiovisual medium, including at least speech, background music, and sound effects.

The term “scene” refers to a time segment of the audiovisual medium defined by a start time and an end time, within which visual and audio characteristics are relatively consistent. The term “scene section” refers to time information that specifies a start time and an end time of a corresponding scene within the audiovisual medium.

The term “scene type” refers to categorical information representing a classification of a scene, such as a kind of situation, activity, or environment depicted in the scene.

The term “appearance subject” refers to an entity, such as a person, character, or object, that is identified as playing a main role or appearing prominently in a scene.

The term “background type” refers to categorical information representing a classification of a background region in a scene, such as an indoor space, outdoor space, natural scenery, or urban scenery.

The term “motion feature” refers to information representing movement characteristics in a scene, including at least motion vectors, camera motion, or object motion patterns. The term “acoustic feature” refers to information derived from audio information of the audiovisual medium, such as a spectrum, a mel spectrogram, or a cepstral coefficient, which describes frequency and temporal characteristics of the sound.

The term “analysis metadata” refers to structured information generated by analysis of video information and audio information of the audiovisual medium, including at least scene sections, scene types, background types, motion features, acoustic features, and an emotional atmosphere. The term “emotional atmosphere” refers to information indicating an overall emotional tendency of a scene, such as joy, tension, sadness, or calm, estimated based on at least the audio information, the acoustic feature, or content of speech and music in the scene.

The term “terminal” refers to an information processing apparatus operated by a user, including at least a display device, an input device, an imaging device, an acoustic acquisition device, a communication interface, and a processor, and configured to reproduce the audiovisual medium and present advertisement content.

The term “imaging information” refers to image data acquired by an imaging device of the terminal, including at least an image in which a face region of a user is captured.

The term “acoustic information” refers to an audio signal acquired by an acoustic acquisition device of the terminal, including at least a sound emitted by a user.

The term “operation history information” refers to information representing operation events performed by the user on the terminal, including at least playback, pause, seek, volume change, advertisement skip, advertisement selection, and evaluation input, and their occurrence times. The term “emotional state” refers to a psychological condition of the user at a given time, such as high-immersion positive, neutral, or bored negative, expressed by at least one label or numerical value.

The term “emotional-state information” refers to information representing an estimated emotional state of the user together with time information associated with reproduction time of the audiovisual medium.

The term “viewing history information” refers to information representing at least content identifiers, viewing durations, completion rates, operation histories, and advertisement viewing and skipping histories related to audiovisual media previously reproduced by the user.

The term “generative AI model” refers to a machine learning model trained in advance on a large amount of data and configured to generate new data, including at least text data, image data, audio data, or a combination thereof, based on an input condition or instruction. The term “prompt sentence” refers to a natural-language instruction sentence supplied to the generative AI model, the prompt sentence specifying at least content, tone, style, target item, and output structure for advertisement content to be generated.

The term “advertisement content” refers to information content generated for promotion of an item or a service, including at least advertisement text information, advertisement image information, and optionally advertisement audio information.

The term “advertisement text information” refers to text data representing at least a slogan, a descriptive body, or a dialogue line included in advertisement content.

The term “advertisement image information” refers to image data representing a visual component of advertisement content to be superimposed on a video frame of the audiovisual medium.

The term “advertisement audio information” refers to audio data representing a narration, a spoken message, or other audio element generated for advertisement content, including at least audio synthesized from advertisement text information.

The term “speech synthesis” refers to processing that converts text data into an audio signal representing synthesized speech using a text-to-speech engine.

The term “object-region information” refers to information indicating a region in a video frame in which an object such as a signboard, a shelf, or a display surface is detected, including at least a position and a size of the region.

The term “background-region information” refers to information indicating a region in a video frame that constitutes a background not belonging to a specific object, including at least a wall surface, a floor, or scenery.

The term “advertisement embedding region” refers to a region in a video frame, including at least one of an object region and a background region, which is selected as a target region for superimposing advertisement image information.

The term “display position” refers to coordinate information specifying where in a video frame advertisement image information is to be displayed.

The term “display size” refers to information specifying a size or a scaling factor with which advertisement image information is to be displayed within a video frame.

The term “display time band” refers to time information specifying a start time and an end time within the audiovisual medium during which advertisement content is to be presented.

The term “projection transformation” refers to a geometric transformation that maps advertisement image information onto an advertisement embedding region so that the advertisement image information is displayed in accordance with a perspective plane or orientation of a surface in the video frame.

The term “composition processing” refers to image processing that superimposes advertisement image information onto a video frame of the audiovisual medium, including at least alpha blending or overlay processing.

The term “display control information” refers to information used by the terminal to control rendering of advertisement image information, including at least an advertisement embedding region, a display position, a display size, a display time band, and projection transformation parameters.

The term “audio control information” refers to information used by the terminal to control mixing of advertisement audio information with audio information of the audiovisual medium, including at least a start time, a volume coefficient, and a fade time.

The term “communication interface” refers to a hardware and software configuration that enables data communication between the server and the terminal over a communication network. The term “feedback information” refers to information transmitted from the terminal to the server, the feedback information including at least one of a viewing completion rate, a skip operation, a selection operation, an evaluation input, and emotional-state information during presentation of advertisement content.

The term “generation rule” refers to a set of procedures, templates, parameters, or algorithms used to construct a prompt sentence based on analysis metadata, emotional-state information, and viewing history information.

The term “learning-based updating” refers to processing that automatically adjusts at least one of the generation rule and a parameter of the generative AI model using a machine learning algorithm or a statistical method based on feedback information and emotional-state information. The term “prompt template” refers to a structural pattern for a prompt sentence that specifies at least fields for scene type, emotional atmosphere, user emotional state, user preference category, advertisement-target item category, and output-format constraint.

The term “tone instructions” refers to information in the prompt sentence specifying a desired emotional or stylistic tone, such as warm, dynamic, calm, or energetic, for advertisement content generated by the generative AI model.

The term “style instructions” refers to information in the prompt sentence specifying a desired style, such as narrative style, conversational style, or formal style, for advertisement content generated by the generative AI model.

The term “output-structure instructions” refers to information in the prompt sentence specifying a structural format of generated advertisement content, such as the presence and order of a slogan, a descriptive body, and a call-to-action sentence.

The term “inference processing engine” refers to software or hardware that executes a pre-trained machine learning model, such as a facial expression recognition model or a speech-emotion recognition model, on the terminal or the server to output estimation results from input data.

In one embodiment, a server, a terminal, and a user cooperate to implement the invention. The server is realized by a general-purpose computer system including at least one central processing unit (CPU), at least one graphics processing unit (GPU), a main memory, a non-volatile storage device, and a network interface. The server operates under a server operating system such as a general-purpose server OS and executes a backend program implemented, for example, in a high-level programming language running on a runtime environment. The server uses software libraries for image processing (for example, an image-processing library), audio processing (for example, an audio-processing library), and machine learning (for example, a deep-learning framework and a natural-language-processing framework). The server optionally accesses an external storage service and an external generative AI model service via a communication network.

The terminal is realized by a user-side information processing device such as a smartphone, a tablet, or a personal computer including at least a display device, a touch-sensitive input device, a processor, a memory, an imaging device, an acoustic acquisition device, and a communication interface. The terminal operates under a client operating system, such as a mobile OS, and executes an application program including a video playback component (for example, a media playback framework), a graphics rendering interface (for example, a graphics API), and a local inference engine (for example, an inference runtime). The terminal stores pre-trained on-device models for facial expression recognition and speech emotion recognition in non-volatile storage. The user operates the terminal to select audiovisual media for playback and to interact with advertisement content, including, for example, tapping embedded advertisement regions, selecting detailed information, or skipping advertisements. The user may also provide explicit feedback, such as rating advertisement content through the user interface.

### Server-Side Content Analysis and Data Structures

The server prepares a data structure called “analysis metadata” in a storage system such as a relational database management system. For each audiovisual medium, the server stores a plurality of records, each record corresponding to a scene. Each scene record contains the following fields: a scene identifier, a start timestamp, an end timestamp, a scene type label, a background type label, motion features, acoustic features, and an emotional atmosphere label. The server uses an image-processing library to decode video frames into a standardized resolution and color space. The server uses a deep-learning framework running on the GPU to execute a video analysis model. In one embodiment, the server uses a convolutional neural network (CNN) combined with a temporal module such as a three-dimensional convolutional network or a temporal convolutional network. The server normalizes input frames and packs them into a four-dimensional tensor (batch size, time length, height, width, channels). The server feeds this tensor to the neural network.

The server obtains, from intermediate layers of the neural network, feature maps representing spatial and temporal patterns of the frames. The server applies a classification head that outputs probability distributions over predefined scene types and background types. The server also applies a boundary-detection head that outputs a scalar “scene boundary score” for each temporal position. The server then post-processes the boundary scores by applying thresholding and non-maximum suppression to detect robust scenechange candidates. The server merges adjacent segments with similar scene-type probabilities and assigns each merged segment a scene identifier, resulting in segments that correspond to scenes.

To compute motion features, the server may either reuse intermediate activations of the temporal convolutional layers or compute optical flow vectors via a classical algorithm such as a gradient-based method accelerated on the GPU. The server stores summary statistics of these vectors, such as average magnitude, direction histograms, or camera-motion descriptors, as motion features. The server extracts the audio track from the audiovisual medium and uses an audio-processing library to resample the waveform to a standardized sampling rate. The server then segments the waveform into overlapping frames and computes acoustic features such as mel-spectrograms and mel-frequency cepstral coefficients (MFCCs). The server uses a speech recognition model, for example, a transformer-based encoder-decoder network, to convert time-aligned acoustic frames into a sequence of text tokens. The server further uses a natural-language-processing model, for example, a transformer-based classifier, to assign emotion labels to chunks of the transcript. The server associates these labels with time ranges in the audiovisual medium.

The server estimates an emotional atmosphere for each scene by aligning the emotion labels with the scene segments. The server, for each scene, aggregates frame-level emotion probabilities using a pooling function (for example, temporal averaging or attention-based pooling) and selects the label with maximum aggregated probability as the emotional atmosphere of the scene. The server stores this label and the probabilities in the analysis metadata.

Terminal-side emotion estimation and data structures

The terminal executes a video playback component that consumes a streaming URL provided by the server and renders audiovisual frames to the display and speaker. The terminal maintains an internal data store, which may be realized using an in-memory store or a lightweight database, that associates playback time positions with scene identifiers and analysis metadata fields received from the server.

The terminal uses the imaging device to capture frames of the user during playback. The terminal applies a face detection algorithm, which may be implemented as a lightweight CNN or a platform-provided face detection API, to identify a face bounding box. The terminal crops and resizes the face region to match the input dimensions required by a facial expression model stored in the terminal. The facial expression model is, in one embodiment, a CNN followed by fully connected layers, trained to classify emotion categories from facial images. The terminal runs this model using an inference runtime optimized for mobile processors.

The terminal uses the acoustic acquisition device to capture audio from the user, such as utterances or exclamations. The terminal segments the captured audio into frames and computes MFCC features. The terminal feeds these features into a speech emotion recognition model, which may be a recurrent neural network (RNN) or a transformer-based sequence classifier trained on labeled emotional speech data. The terminal obtains probability distributions over emotion categories such as positive, negative, and high arousal.

In addition to sensor data, the terminal logs user operations, such as play, pause, seek, changing volume, pressing an advertisement skip button, or tapping an embedded advertisement. The terminal records each operation with a timestamp and the corresponding playback time position. The terminal periodically derives a comprehensive emotional state for the user. In one embodiment, the terminal uses a rule-based engine in which predefined rules map combinations of facial expression scores, speech emotion scores, and operation frequencies into emotional-state labels. For example, if the probability of joy is above a threshold and the number of seek operations in a time window is below a threshold, the rule may assign a “high-immersion positive” state. Alternatively, the terminal may use a small feed-forward neural network receiving concatenated feature vectors (for example, last N facial scores, last N speech emotion scores, and operation statistics) and producing emotional-state labels. The terminal thereby produces emotional-state information that includes a label and a numerical vector aligned with playback time.

The terminal compresses or batches multiple emotional-state records and sends them via the communication interface to the server. The terminal includes, for each record, the playback timestamp, the emotional-state label, and confidence scores. By performing these estimations locally, the terminal reduces bandwidth usage because raw images and raw audio are not transmitted to the server.

Server-side prompt sentence generation and generative AI model integration

The server maintains a separate data structure called “prompt template.” A prompt template is defined as a string pattern with placeholders for attributes such as scene type, emotional atmosphere, current emotional state, user preference categories, advertisement-target item category, and output-format constraints. The server stores multiple prompt templates tuned for different categories of scenes, such as cooking scenes, sports scenes, or technology scenes. The server, upon receiving emotional-state information from the terminal, looks up the analysis metadata for the current scene in its database. The server also retrieves the viewing history information of the user, including frequent content categories and past interactions with advertisement content. The server selects a prompt template corresponding to the current scene type and advertisement-target category. The server fills each placeholder of the template using the retrieved metadata and user state.

For example, if the current scene is a cooking show scene with a joyful atmosphere, the user's emotional state is “high-immersion positive,” and the user has shown interest in kitchen appliances, the server constructs a prompt sentence such as:

“The user is watching a cooking show scene where a chef is stir-frying vegetables in a bright, cozy kitchen. The scene atmosphere is joyful and relaxed. The user's current emotional state is ‘high-immersion positive,’ and the user is interested in kitchen appliances. In natural, warm Japanese, create an advertisement script for an IH-compatible frying pan that fits seamlessly into this scene. The script must include:
(1) a short, catchy slogan,
(2) a 100-150-character body text describing key functions and benefits,
(3) one short line of dialogue spoken by the chef to the viewer.”

In another example, if the current scene is a near-future city night scene in a technology-related video and the user's emotional state is “excited,” the server constructs a prompt sentence such as: “The user is watching a technology video scene of a futuristic city at night and feels highly excited. The user is interested in new information devices. In dynamic and energetic Japanese, create an advertisement script for a new smart device that matches this scene. The ad script must include:
(1) an impactful catchphrase,
(2) a body text introducing the main features,
(3) a closing sentence that encourages the viewer to take action.”

The server sends the constructed prompt sentence to a generative AI model implemented as a large language model (LLM). In one embodiment, the LLM is a transformer-based model with multiple self-attention layers, feed-forward sublayers, and position-encoding schemes, trained on a large corpus of text. The server inputs the prompt sentence as a sequence of token identifiers to the LLM and obtains a sequence of output tokens representing advertisement text information. The server parses the generated output according to the constraints specified in the prompt sentence. For example, the server detects numbered sections “(1)”, “(2)”, “(3)” and splits the text into a slogan, a body text, and a dialogue line. The server then performs keyword extraction using a natural-language-processing pipeline, which may include tokenization, part-of-speech tagging, and a simple rule-based filter for nouns and adjectives. The server identifies product attributes such as type (for example, frying pan), material, color, and usage context (for example, home kitchen).

The server constructs a separate prompt sentence for an image generative AI model. For instance, the server may create:

“A high-resolution photo of a modern IH-compatible frying pan on a clean kitchen counter, fresh vegetables being stir-fried, warm and soft lighting, cinematic style, 4K.”

The server sends this prompt sentence to an image generative AI model such as a diffusion-based generative model. In one embodiment, the image generative AI model consists of a denoising network with a U-Net architecture combined with a text encoder. The text encoder transforms the prompt sentence into an embedding vector used to condition the denoising process. The server provides random noise as input to the diffusion process and iteratively refines the noise according to the predicted denoising steps until a final image is produced.

The server receives an image representing advertisement image information, converts the image to a standardized graphics format (for example, PNG) with optional transparency, and resizes it to a resolution that can be embedded into target regions of a video frame without excessive scaling. The server also selects parts of the advertisement text information for narration and passes them to a text-to-speech engine that uses a sequence-to-sequence neural network with attention or a neural vocoder to synthesize audio. The server obtains advertisement audio information as a waveform and normalizes its loudness.

Embedding control, data structures, and technical effects

The server computes embedding control information based on analysis metadata and advertisement content. The server retrieves object-region information and background-region information associated with the current scene from the database. Each region is stored as a rectangle or polygon with coordinates in normalized screen space. The server evaluates each candidate region using a scoring function that considers at least region size, relative position, and overlap with important regions such as faces.

The server determines an advertisement embedding region by selecting the candidate with the highest score subject to constraints on minimum area and visibility. The server computes projection transformation parameters, for example, a homography matrix mapping the advertisement image rectangle to the polygon of the target region. The server also determines a display time band based on the scene duration and an avoidance of rapid scene changes. The server stores these parameters in a structure representing display control information. The server analyzes the acoustic features to identify speech-heavy intervals and background-music-only intervals using a classifier, which may be a neural network receiving time-frequency features and outputting a probability of speech presence. The server chooses a narration start time in a music-only interval when possible. The server sets volume coefficients and fade times in audio control information such that the advertisement audio information is mixed at an appropriate level relative to the audio information of the audiovisual medium.

By performing these computations on pre-structured metadata and explicit region and time-band data, the system improves technical performance in several ways. The server avoids heavy per-frame image processing at playback time by precomputing region candidates and storing them as simple geometrical structures. The selection and transformation of advertisement image information then require only lightweight matrix operations on the terminal's graphics pipeline. This reduces computation load and improves responsiveness of rendering on resource-constrained devices.

Terminal-side rendering, mixing, and real-world device control

The terminal receives display control information, audio control information, advertisement image information, and advertisement audio information from the server. The terminal stores these in local memory structures indexed by scene identifier and playback time. The terminal monitors playback time using callbacks from the video playback component.

When the current playback time enters a display time band specified in display control information, the terminal creates a texture from advertisement image information using a graphics API such as OpenGL ES or an equivalent. The terminal configures a vertex buffer corresponding to the coordinates of the advertisement embedding region and applies the projection transformation matrix to draw the texture in perspective alignment with the detected surface (for example, a billboard plane or a shelf surface). The terminal composes this texture with the underlying video frame in a fragment shader. Because the transformation is performed in the GPU, the blending operation is efficient, and the embedded advertisement appears visually coherent with the original scene.

Simultaneously, the terminal uses an audio API to create a secondary audio stream for advertisement audio information. The terminal schedules playback of this stream at the start time specified in audio control information. The terminal adjusts the volume of both the advertisement audio information and the audio information of the audiovisual medium in real time according to volume coefficients and fade times. The terminal thereby directly controls the speaker hardware to output a mixed audio signal that aligns in time with the advertisement visuals.

In this manner, the system does not operate solely on abstract data; the processing results directly control physical devices such as the display and speaker. The system adjusts rendering parameters, mixing levels, and timing based on computed metadata, which constitutes a concrete improvement in how audiovisual content is processed at the device level.

Learning-based updating and technical improvement

The server receives feedback information from the terminal, including viewing completion rates, skip events, selection events, evaluation inputs, and emotional states during advertisement presentation. The server stores these in a feedback database keyed by advertisement identifier, user identifier, scene identifier, and time. The server then computes statistical features such as skip rate as a function of emotional state or scene type, and changes in emotional state before and after advertisement presentation.

The server trains a model that maps context features (for example, scene type, emotional atmosphere, user preference categories, recent emotional state) to prompt-template parameters (for example, tone instructions and style instructions). In one embodiment, this model is a feed-forward neural network optimized by minimizing a loss function defined over historical feedback data. The loss function may penalize high skip rates or negative emotion changes and reward clicks or positive emotion changes. The server updates the weights of this network using gradient descent.

The server then uses outputs of this learned model to adjust the selection of prompt templates and to modify parts of prompt sentences such as tone and style instructions. Because the server updates an internal control mechanism that generates prompt sentences rather than simply adding more business rules, the system improves the effectiveness of generative AI model usage in a technical way. The model reduces the need for repeated human tuning of prompts and can quickly adapt to new patterns in user behavior.

The server may also fine-tune the generative AI model parameters. For example, for a text generative AI model, the server may periodically perform supervised fine-tuning using pairs of prompt sentences and target advertisement texts that have produced favorable feedback. The server computes a loss function such as cross-entropy between the generated tokens and desired tokens, and updates model parameters via backpropagation. For an image generative AI model, the server may adjust conditioning weights to bias the model toward styles that historically produced lower skip rates or higher engagement.

By tying model updates to explicit feedback that includes time-aligned emotional-state information, the system improves the accuracy and relevance of advertisement generation. Compared with a system that simply executes a static generative model, this feedback loop constitutes an improvement in the computing system itself: the generative inference becomes more efficient in achieving desired outcomes, and the server's processing pipeline can reduce wasted computation on advertisement content that would likely be skipped.

Technical advantages and non-abstract improvements

The system improves computer technology in multiple dimensions. First, by structuring multi-modal data (video, audio, and user state) into well-defined analysis metadata and emotional-state records, the server and terminal can process the data using specialized data structures. This allows efficient indexing, caching, and lookup, reducing latency when generating and embedding advertisements.

Second, by performing part of the emotion estimation computation on the terminal using optimized on-device models, the system reduces communication load because raw sensor data do not need to be sent to the server. This reduces bandwidth usage and improves privacy while still delivering high-quality emotional-state information to the server.

Third, by using prompt templates and a learned mapping from context to prompt parameters, the system improves the utilization of generative AI models. The generative models are not merely generic text or image generators; they are incorporated into a control loop that dynamically adjusts their input space based on computed metadata and feedback. This design enables more accurate and faster convergence to context-appropriate advertisement content and reduces computational overhead by avoiding unnecessary sampling of poorly performing styles. Fourth, by computing embedding control information and audio control information in advance and encoding them into compact transformation and mixing parameters, the system offloads heavy analysis tasks from the terminal. The terminal requires only lightweight matrix operations and real-time mixing operations at playback time, leading to improved frame rates, reduced jitter, and lower energy consumption on battery-operated devices.

Fifth, by using learning-based updating mechanisms that adjust generation rules and model parameters based on explicit, time-aligned feedback, the system continuously optimizes its internal processing. This is not a mere automation of human tasks such as manual copywriting; it is a technical method to improve algorithmic behavior in content analysis, prompt construction, and generative inference. As a result, the system can reduce error rates in emotional-state classification, increase precision in embedding placement, and improve the overall quality of media rendering pipelines.

### Alternative Embodiments and Variations

The server may employ different neural network architectures for scene analysis, such as transformer-based video models or hybrid CNN-transformer models. The particular choice of model architecture can be adapted to trade off between accuracy and computational cost. The server may also employ different emotion classifiers, such as models trained explicitly on multi-lingual speech data or models that incorporate prosodic features in addition to spectral features. The terminal may implement emotional-state estimation using purely rule-based logic without a neural network, for environments with stricter resource constraints. For example, the terminal may estimate boredom when there are frequent seek operations and low variation in facial expression scores. Conversely, high engagement may be detected when the user faces the screen steadily, shows positive expressions, and rarely manipulates playback controls.

The prompt template mechanism can be extended with additional fields, such as a maximum allowed length for generated text or a desired narrative perspective (for example, first-person vs. third-person). The server may maintain multiple generative AI models specialized for different product categories and route prompt sentences to appropriate models based on advertisement-target categories.

The server may also support offline operation by precomputing and caching advertisement content for likely scene and user combinations, using stored viewing history patterns. In such a case, the terminal can retrieve pre-generated advertisement content and embedding control information with reduced latency.

The system can be applied not only to traditional video-on-demand services but also to live streaming scenarios. In a live streaming embodiment, the server may analyze a sliding window of video and audio and update analysis metadata in near real time. The prompt sentence generation and content embedding then operate on this rolling metadata, enabling dynamic advertisement insertion into live video with context-sensitive adaptation.

In all these embodiments, the server, the terminal, and the user cooperate through concrete data structures, algorithms, and device control processes to realize the functions claimed. The technical implementation as described integrates generative AI models, prompt sentence construction, multimodal emotion estimation, and rendering control into a cohesive system that enhances the underlying computer technology, rather than merely automating a human task.

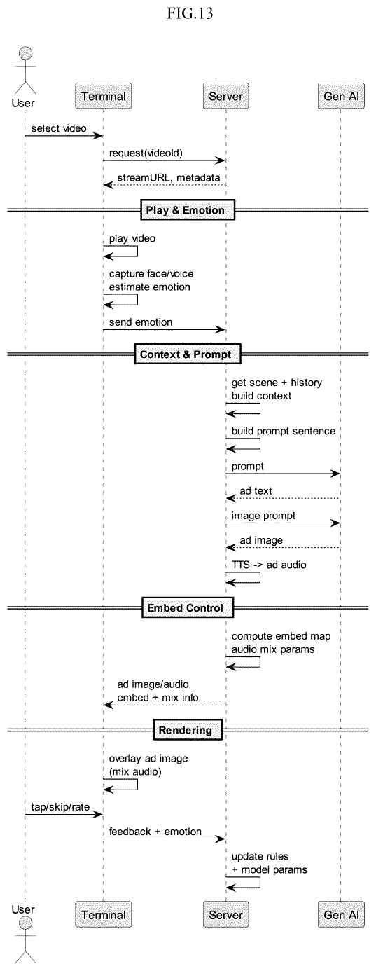

The following describes the processing flow using FIG. 13.

### Step 1:

The server receives, as input, a content identifier for an audiovisual medium from the terminal or a content distribution platform. The server uses a media processing library to fetch the corresponding media file or stream and demultiplexes it into video information (frames) and audio information (waveform data). The server converts each video frame to a standardized resolution and color space and resamples the audio waveform to a standard sampling rate. The server outputs a normalized frame sequence and a normalized audio waveform that serve as input for later analysis steps.

### Step 2:

The server takes, as input, the normalized frame sequence from Step 1 and feeds batches of frames into a video analysis model implemented in a deep-learning framework. The server converts frames into tensors, performs forward passes through a neural network (for example, a convolutional or transformer-based network), and obtains per-frame or per-window probabilities for scene types, background types, and scene boundary scores. The server then clusters contiguous frames with similar probabilities and applies thresholding on boundary scores to segment the audiovisual medium into scenes. The server outputs preliminary scene sections, each with a start time, an end time, and provisional labels.

### Step 3:

The server receives, as input, the normalized audio waveform from Step 1 and the preliminary scene sections from Step 2. The server segments the waveform into overlapping time windows, computes acoustic features such as mel-spectrograms or cepstral coefficients, and feeds these features into a speech recognition model to obtain transcript segments and into an emotion classification model to obtain emotion probabilities over time. The server aligns the time indices of transcript segments and emotion probabilities with the scene sections and aggregates frame-level emotion probabilities within each scene (for example, by averaging or attention-based pooling) to estimate an emotional atmosphere label per scene. The server outputs analysis metadata that includes, for each scene, the scene section, scene type, background type, motion and acoustic features, and emotional atmosphere.

### Step 4:

The server takes, as input, a subset of video frames and the analysis metadata from Step 3. The server applies an object and background region detection model (for example, an object detector) to each frame to detect candidate regions such as shelves, walls, billboards, or screens. The server records, for each detected region, coordinates, size, and a classification label (object region or background region). The server associates detected regions with corresponding scene sections based on time indices and summarizes them into object-region information and background-region information per scene. The server outputs extended analysis metadata that now includes explicit candidate embedding regions.

### Step 5:

The terminal receives, as input, a content identifier selected by the user and sends a request to the server. The server responds with a streaming URL for the audiovisual medium and the extended analysis metadata from Step 4. The terminal configures its video playback component with the streaming URL and begins playback. The terminal parses and stores the analysis metadata locally in a data structure indexed by playback time, so that for any current playback time, the terminal can output the corresponding scene identifier and associated scene attributes.

### Step 6:

The terminal takes, as input, the current playback state and user permission for camera and microphone use. The terminal activates the imaging device and acoustic acquisition device and periodically captures camera frames and microphone audio segments. The terminal runs a face detection algorithm on each camera frame, crops and resizes the face region, and normalizes pixel values. The terminal feeds the preprocessed face image into a facial expression recognition model using an inference engine and obtains expression scores such as joy, surprise, or neutral. For audio, the terminal segments the recorded audio, computes acoustic features such as MFCCs, inputs these features into a speech emotion recognition model, and obtains probabilities for emotional categories such as positive, negative, or tense. The terminal timestamps these scores with the current playback time and outputs raw emotion-signal records.

### Step 7:

The terminal receives, as input, the raw emotion-signal records from Step 6 and an operation history log that records user actions such as play, pause, seek, skip, and advertisement taps, each with a playback timestamp. The terminal aggregates emotion-signal records and operation events over a sliding time window and constructs a feature vector that includes facial expression scores, speech emotion scores, and statistics of operation frequencies. The terminal applies either a rule-based engine or a lightweight neural classifier to this feature vector to infer a comprehensive emotional state label (for example, “high-immersion positive,” “neutral,” or “bored negative”) and a confidence score. The terminal then associates this label with the current playback time, creating an emotional-state information record. The terminal outputs a sequence of such emotional-state information records.

### Step 8:

The terminal collects, as input, the emotional-state information records generated in Step 7 and batches them according to a predetermined time interval or number of records. The terminal packages each batch with the content identifier and a user/session identifier and sends the package to the server via the communication interface. If network transmission fails, the terminal temporarily stores the package in local memory and retries later. The server receives the package, validates timestamps and data formats, and writes the emotional-state information into a server-side data store indexed by user, content, and time. The server outputs a continuously updated emotional-state timeline per user and content session.

### Step 9:

The server reads, as input, the extended analysis metadata from Step 4 and the emotional-state timeline from Step 8 for the current playback position, as well as viewing history information for the user from its database. The server identifies the current scene section based on the latest playback time and obtains its scene type, emotional atmosphere, and candidate embedding regions. The server analyzes viewing history to determine user preference categories and advertisement-target item categories. The server outputs a summarized context vector including scene attributes, emotional atmosphere, user emotional state, and user preferences.

### Step 10:

The server takes, as input, the summarized context vector from Step 9 and a stored prompt template corresponding to the current scene type and advertisement-target category. The server fills placeholders in the prompt template with values from the context vector, such as a description of the scene, the emotional atmosphere, the user's current emotional state, the user's preference category, and the required output structure for the advertisement content. The server concatenates these elements into a natural-language prompt sentence. For example, the server generates a prompt sentence such as:

“The user is watching a cooking show scene where a chef is stir-frying vegetables in a bright, cozy kitchen. The scene atmosphere is joyful and relaxed. The user's current emotional state is ‘high-immersion positive,’ and the user is interested in kitchen appliances. In natural, warm Japanese, create an advertisement script for an IH-compatible frying pan that fits seamlessly into this scene. The script must include:
(1) a short, catchy slogan,
(2) a 100-150-character body text describing key functions and benefits,
(3) one short line of dialogue spoken by the chef to the viewer.”

The server outputs the constructed prompt sentence to be supplied to a generative AI model.

### Step 11:

The server uses, as input, the prompt sentence from Step 10 and calls a text generative AI model, such as a transformer-based large language model, via an inference API. The server tokenizes the prompt sentence, feeds token sequences into the model, and receives output tokens representing generated advertisement text. The server decodes tokens into a text string and parses the string according to the structural constraints specified in the prompt (for example, sections labeled (1), (2), and (3)). The server separates the slogan, body text, and dialogue line and runs a keyword extraction process to identify product attributes, colors, usage context, and style hints. The server outputs structured advertisement text information and a set of extracted keywords.

### Step 12:

The server takes, as input, the structured advertisement text information and the extracted keywords from Step 11. The server constructs a second prompt sentence for an image generative AI model by combining keywords with visual descriptors, for example:

“A high-resolution photo of a modern IH-compatible frying pan on a clean kitchen counter, fresh vegetables being stir-fried, warm and soft lighting, cinematic style, 4K.”

The server sends this image prompt sentence to an image generative AI model, such as a diffusion-based model, and receives an image sample as output. The server converts the image to a standard format, optionally adds an alpha channel, and rescales the image to a resolution suitable for overlay on a video frame. In parallel, the server selects parts of the advertisement text information (for example, the body text and dialogue line) and sends them to a text-to-speech engine, which synthesizes advertisement audio information. The server normalizes audio volume and stores both advertisement image information and advertisement audio information. The server outputs a complete advertisement content package including text, image, and audio.

### Step 13:

The server receives, as input, the complete advertisement content package from Step 12 and the extended analysis metadata from Step 4. The server identifies, for the current scene, all candidate object and background regions and evaluates each candidate with a scoring function that considers region size, centrality in the frame, and overlap with important content such as faces. The server selects the highest-scoring region as the advertisement embedding region and computes geometric parameters such as a homography or transformation matrix that maps the advertisement image rectangle to the region polygon. The server determines an appropriate display time band within the scene by analyzing scene duration and avoiding rapid transitions. The server outputs display control information including the advertisement embedding region, display position, display size, display time band, and projection transformation parameters.

### Step 14:

The server uses, as input, the audio information of the audiovisual medium and the advertisement audio information from Step 12. The server analyzes the audio information with a speech-activity classifier to segment time intervals into speech-dominant intervals and background-music-dominant intervals. The server selects a start time for playback of the advertisement audio information, preferably in a background-music-dominant interval, and calculates volume coefficients for both the original audio and the advertisement audio so that dialogue remains intelligible but the advertisement narration is also audible. The server sets fade-in and fade-out durations to avoid abrupt changes in sound level. The server outputs audio control information including the narration start time, volume coefficients, and fade times.

### Step 15:

The server bundles, as input, the display control information from Step 13, the audio control information from Step 14, and the advertisement content package from Step 12. The server encapsulates these data into a control message associated with the user's current session and sends the message to the terminal via the communication interface. The terminal receives the control message, parses the display and audio control information, and caches the advertisement image and audio in local memory. The terminal then associates the control parameters with the corresponding playback timeline of the audiovisual medium. The terminal outputs an internal schedule for when and how to render the advertisement content.

### Step 16:

The terminal references, as input, the internal schedule from Step 15 and the current playback time obtained from the video playback component. When the playback time enters a display time band, the terminal reads the corresponding advertisement image information and projection transformation parameters. The terminal uses a graphics API to create a texture from the advertisement image, sets up vertex coordinates matching the advertisement embedding region on the video frame, and applies the projection transformation to render the image in perspective alignment. The terminal blends the advertisement texture with the underlying video frame in the GPU pipeline and outputs the composited frame to the display device. The terminal thereby superimposes the advertisement as part of the scene's object or background.

### Step 17:

The terminal reads, as input, the audio control information from Step 15 and the advertisement audio information. When the playback time reaches the narration start time defined in the audio control information, the terminal starts playback of the advertisement audio on a secondary audio stream. The terminal applies the specified volume coefficients and fade-in/fade-out curves, while adjusting the level of the original audio information to avoid masking speech or over-amplifying the advertisement audio. The terminal mixes the two audio streams in real time via the audio subsystem of the operating system and outputs the mixed signal to the speaker or connected audio output device.

### Step 18:

The user views, as input, the audiovisual medium with embedded advertisement content on the terminal display and listens to the mixed audio. The user may tap the advertisement region to open a detailed product view, press a visible skip button to terminate the advertisement, or provide an explicit evaluation input such as a like/dislike signal. The terminal detects these user interactions as events, records the event type, playback time, associated advertisement identifier, and the current emotional-state label from Step 7, and appends them to a local feedback log. The terminal outputs aggregated feedback information reflecting the user's behavior and reactions to the advertisement content.

### Step 19:

The terminal collects, as input, the feedback information from Step 18 together with any unsent emotional-state information from Step 7 and sends them to the server via the communication interface. The server receives these records, validates and stores them, and computes performance metrics such as advertisement viewing completion rate, skip rate, selection rate, and emotional-state changes before and after advertisement presentation. The server uses these metrics as training data for updating the generation rule used in Step 10 and, optionally, for fine-tuning parameters of the generative AI models used in Steps 11 and 12. The server executes a learning algorithm, such as gradient descent on a loss function that encodes skip penalties and engagement rewards, and adjusts model weights or template parameters. The server outputs updated generations rules and model parameters that will be used in subsequent executions of Steps 10 through 12, thereby improving the quality and efficiency of future advertisement generation and embedding.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented advertising systems that insert or overlay advertisements into digital environments, such as video content or virtual spaces, typically rely on coarse user data, for example static demographic profiles or simple viewing histories. In many cases, these systems select advertisements or determine insertion timing based on aggregated statistics or preset rules that do not fully exploit real-time behavioral signals and do not account for a user's emotional state in a structured, machine-readable form. As a result, the computer systems involved often operate with suboptimal decision logic that fails to adaptively control the generation and display of advertisements at a fine-grained level, leading to lower click-through rates, reduced conversion rates, and degraded user experience.

Furthermore, in many existing systems, the generation of advertising content is decoupled from low-level interaction signals such as gaze trajectories, precise operation sequences, and micro-patterns in browsing behavior within an interface. Even when machine learning is used, the models often operate on simplified features derived from viewing logs and do not integrate multi-modal emotion recognition results, such as facial expressions and voice-based emotion scores. Consequently, the internal computation pipeline of the advertising system underutilizes available sensor and interaction data, and the mapping from user state to ad policy remains coarse and static, which limits the ability of the system to adjust the tone, information density, and format of the advertisement in real time.

In addition, typical systems that employ generative AI models for creating advertisement texts or images usually invoke such models with generic or manually authored prompts. The prompt construction process rarely encodes a structured advertising policy that reflects computed interest degrees, purchase intention degrees, and emotion scores. This causes inefficiencies at the prompt-engineering layer: the generative AI model is not guided by machine-derived, context-specific parameters, and the resulting content may be emotionally mismatched or cognitively overloading for the user. This mismatch not only reduces the effectiveness of the advertisement but also increases the computational waste in the generative pipeline, because the system cannot systematically learn from outcomes to refine prompt generation strategies.

Moreover, the feedback loop from ad performance back into the core decision-making components is often shallow. While some systems log clicks or skips, they do not maintain a structured correspondence between (i) the exact prompt sentence used to drive a generative AI model, (ii) the advertising policy parameters used to generate that prompt, (iii) the resulting advertisement content, and (iv) the measured changes in user emotion and behavior before and after the ad display. Without such structured learning data, the system cannot robustly update its internal models or rules. As a result, the computer system remains largely static, with limited capability to self-optimize at the levels of ad policy, prompt design, and generative content selection.

There is therefore a need for a computer-implemented advertising system that improves the underlying computing technology by: (i) systematically acquiring and processing multi-modal user data including gaze, position, operation logs, and detailed browsing histories; (ii) computing behavior-based interest and purchase intention degrees together with multi-dimensional emotion scores; (iii) integrating these computed measures into an explicit, machine-readable advertising policy; (iv) automatically generating prompt sentences for a generative AI model based on the advertising policy and item metadata; (v) generating text, image, or video advertisements through the generative AI model; (vi) controlling ad display behavior in real time in response to gaze and interaction inputs; and (vii) closing the loop by storing structured learning data that link prompt sentences, policy parameters, emotion changes, and operation outcomes, and by updating internal models based on the learning data. By realizing this architecture, the invention aims to enhance the efficiency, adaptiveness, and technical performance of computer systems responsible for generating and displaying personalized advertisements.

The specific processing by the specific processing unit 290 of the data processing device 12 in Application Example 2 is realized by the following means.

The present invention provides a server comprising a processor configured to function as a user behavior analysis unit that acquires gaze information, position information, operation information, and browsing history information from a terminal, and calculates, based on the gaze information, the position information, the operation information, and the browsing history information, an interest degree for each attribute category of a target item and a purchase intention degree for the target item; the processor further configured to function as an emotion recognition unit that acquires face image information and voice information from the terminal and applies a machine learning model to the face image information and the voice information to calculate emotion scores corresponding to a plurality of types of emotions of a user; the processor further configured to function as an advertising policy determination unit that determines advertising policy information including an appeal direction, an information amount, an expression tone, a display timing, and a display format of an advertisement based on the interest degree, the purchase intention degree, and the emotion scores; the processor further configured to function as an advertising generation unit that, based on the advertising policy information and on attribute information and evaluation information of the target item, automatically generates a prompt sentence to be input to a generative AI model, inputs the prompt sentence to the generative AI model, and generates at least one of a text advertisement, an image advertisement, and a video advertisement; the processor further configured to function as an advertising display unit that causes the text advertisement, the image advertisement, or the video advertisement to be superimposed and displayed at a predetermined position and at a predetermined timing within a display region of an environment or content presented to the user, and controls a display mode of the advertisement or an expansion of detailed information of the advertisement in accordance with a gaze position and an operation input of the user during display of the advertisement; and the processor further configured to function as a learning update unit that acquires a change in the emotion scores before and after the display of the advertisement and an operation result of the user with respect to the advertisement, stores, as learning data, a correspondence among the prompt sentence, the advertising policy information, the change in the emotion scores, and the operation result, and updates processing contents of the advertising policy determination unit and the advertising generation unit based on the learning data. This enables improvement of the computer system's internal operation by allowing the server to dynamically compute user-specific behavior and emotion states, to convert such states into structured advertising policy information, to automatically construct and refine prompt sentences for a generative AI model, to generate and display advertisements that are adaptively matched to the user's current context, and to iteratively optimize the underlying decision logic and generative processes through a closed feedback loop grounded in measured emotional and behavioral outcomes.

The term “system” refers to a collection of hardware and software components that cooperate to execute information processing for generating, controlling, and updating advertisements as described herein.

The term “server” refers to an information processing apparatus including at least one processor, a memory, and a communication interface, configured to communicate with one or more terminals and to execute the functions of the user behavior analysis unit, the emotion recognition unit, the advertising policy determination unit, the advertising generation unit, the advertising display unit, and the learning update unit.

The term “processor” refers to one or more hardware computation units, such as a central processing unit, a graphics processing unit, or a specialized accelerator, that execute instructions stored in a memory to perform arithmetic and logical operations implementing the functions described in the present specification.

The term “terminal” refers to a user-operated information processing apparatus equipped with at least a display device and one or more input devices, and optionally a camera and a microphone, such as a smartphone, a tablet, a head-mounted display, or a personal computer, which communicates with the server and presents content and advertisements to the user. The term “user” refers to a human operator who interacts with the terminal, views content or an environment presented on the terminal, and provides explicit or implicit input signals including gaze, operations, and voice.

The term “user behavior analysis unit” refers to functionality implemented by the processor that acquires and analyzes user-related signals such as gaze information, position information, operation information, and browsing history information, and that computes, based on these signals, an interest degree and a purchase intention degree for items or categories.

The term “emotion recognition unit” refers to functionality implemented by the processor that acquires face image information and voice information from a terminal, applies at least one machine learning model to these inputs, and outputs emotion scores representing a user's emotional state.

The term “advertising policy determination unit” refers to functionality implemented by the processor that uses at least the interest degree, the purchase intention degree, and the emotion scores as inputs, and determines advertising policy information including parameters such as an appeal direction, an information amount, an expression tone, a display timing, and a display format for an advertisement.

The term “advertising generation unit” refers to functionality implemented by the processor that, based on advertising policy information and on attribute information and evaluation information of a target item, automatically generates a prompt sentence for a generative AI model, inputs the prompt sentence to the generative AI model, and generates advertising content including at least one of text, image, and video.

The term “advertising display unit” refers to functionality implemented by the processor that causes generated advertising content to be superimposed and displayed at a predetermined position and timing within a display region of an environment or content, and that controls a display mode or a detail expansion of the advertisement in response to user gaze and operation input.

The term “learning update unit” refers to functionality implemented by the processor that acquires changes in emotion scores before and after advertisement display, as well as user operation results related to the advertisement, stores correspondences among such data, prompt sentences, and advertising policy information as learning data, and updates processing logic or parameters of other units based on the learning data.

The term “gaze information” refers to data indicating at least a position on a display or an object within a presented environment that the user is visually fixating on, such data being derived from sensor signals such as camera images or dedicated eye-tracking sensors.

The term “position information” refers to data representing the location of the user's viewpoint or avatar within a presented environment or content space, or coordinates indicating the user's relative location with respect to displayed objects.

The term “operation information” refers to data representing user actions input via an input device, including at least touch inputs, button presses, pointing device operations, gesture inputs, and keystrokes, as recognized by the terminal or the server.

The term “browsing history information” refers to time-series data that record which items or content segments have been displayed to or accessed by the user, including at least item identifiers, viewing start times, viewing end times, and view counts.

The term “interest degree” refers to a quantitative measure, such as a numeric score or probability, calculated based on user behavior data including browsing history information, gaze information, position information, and operation information, indicating a level of user interest in an item or a category of items.

The term “purchase intention degree” refers to a quantitative measure, such as a numeric score or probability, calculated based on user behavior data including browsing history information, add-to-cart events, and past purchases, indicating a likelihood that the user will purchase an item or an item in a category.

The term “face image information” refers to image or video data that include at least a facial region of the user, captured by a camera and used as input to an emotion recognition or analysis process.

The term “voice information” refers to audio data including at least the user's speech or utterances, captured by a microphone and used as input to an emotion recognition or analysis process.

The term “emotion scores” refers to one or more quantitative values, such as numeric scores or probabilities, output by a machine learning model to represent intensities or likelihoods of multiple emotion types, such as joy, excitement, anxiety, confusion, boredom, stress, or satisfaction.

The term “machine learning model” refers to a computational model trained on data using a machine learning algorithm, including but not limited to linear models, tree-based models, neural networks, and deep learning models, that maps input features to output values such as emotion scores or classification results.

The term “advertising policy information” refers to structured data that specify parameters governing the generation and display of advertisements, including at least an appeal direction, an information amount, an expression tone, a display timing, and a display format.

The term “appeal direction” refers to a specification of a conceptual or emotional focus of an advertisement, such as emphasizing reassurance, excitement, reliability, or cost-effectiveness. The term “information amount” refers to a specification of the quantity or depth of information to be included in an advertisement, such as concise messaging or detailed explanations.

The term “expression tone” refers to a specification of the style or mood of language and visuals used in an advertisement, such as calm, formal, friendly, or energetic.

The term “display timing” refers to a specification of when an advertisement is presented within a user's interaction sequence or within content playback, including absolute or relative time or event-based triggers.

The term “display format” refers to a specification of the media type or presentation style of an advertisement, including at least text, image, and video, and possibly combinations thereof. The term “attribute information” refers to structured data describing properties of a target item, such as a category, specifications, functions, price, warranty, or other descriptive characteristics. The term “evaluation information” refers to data representing assessments of a target item by users or systems, including ratings, review texts, feedback indicators, and aggregated metrics. The term “generative AI model” refers to a machine learning model that, given an input including at least a prompt sentence or condition, generates new data such as text, images, audio, or video, based on patterns learned from training data.

The term “prompt sentence” refers to text input that instructs or conditions a generative AI model regarding desired content, constraints, tone, style, or other aspects of the output to be generated. The term “text advertisement” refers to advertising content primarily composed of textual information, such as written descriptions or promotional messages generated by or with the assistance of a generative AI model.

The term “image advertisement” refers to advertising content that includes graphical or photographic elements, optionally combined with text, generated by or with the assistance of a generative AI model and suitable for display as a still image.

The term “video advertisement” refers to advertising content that includes a sequence of images or frames, optionally combined with audio such as narration or sound effects, generated or composed by or with the assistance of a generative AI model or media processing system.

The term “environment or content” refers to digital information presented to the user, including at least a virtual space, a graphical user interface, a video, or other multimedia content, within which advertisements can be displayed.

The term “display region” refers to a spatial area on a display device or within a graphical rendering area in which content and advertisements are visually presented to the user.

The term “gaze position” refers to a location on a display or in a rendered scene that is determined to be the user's focus of visual attention, typically inferred from eye-tracking data or face image analysis.

The term “operation result” refers to a record of an outcome of a user's interaction with an advertisement or related interface element, such as clicking, tapping, skipping, closing, or marking as a favorite.

The term “learning data” refers to a collection of structured records that store correspondences among prompt sentences, advertising policy information, emotion scores, operation results, and related contextual information, which are used to train or update models or rules within the system.

The term “processing contents” refers to specific procedures, rules, parameters, or model configurations executed by units such as the advertising policy determination unit and the advertising generation unit, which can be updated based on learning data.

The term “history information” refers to stored data describing past user behavior and system interactions, including at least viewing history of content, advertisement viewing duration, advertisement skip rate, operation history, and purchase history.

The term “visual elements” refers to components of an advertisement that are perceivable visually, such as text layout, images, colors, shapes, animations, or graphical styles. The term “auditory elements” refers to components of an advertisement that are perceivable by hearing, such as narration, music, sound effects, or synthesized speech.

The term “metadata” refers to descriptive or structural information associated with content, such as tags, categories, timestamps, device information, or configuration parameters, used to interpret, organize, or process the content.

The term “interest state” refers to a condition of the user characterized by one or more interest-related measures, including at least an interest degree and a purchase intention degree, indicating the user's attraction to an item or category.

The term “emotion state” refers to a condition of the user characterized by one or more emotion scores indicating intensities or probabilities of emotional categories at a given time or time interval.

In one embodiment, a server and one or more terminals cooperate to implement the invention. The terminal comprises at least a display device, a processor, a memory, a communication interface, and one or more input devices such as a touch sensor, a pointing device, a button interface, and optionally a camera and a microphone. The server comprises at least one central processing unit (CPU), one or more graphics processing units (GPUs) or accelerators, a main memory, a non-volatile storage device, and a network interface, and executes a server operating system such as a general-purpose server operating system and middleware such as a web application framework and a database management system.

The terminal executes an application that presents an environment or content to the user, for example a virtual store, an interactive user interface, or multimedia content. The terminal uses a graphics engine such as a three-dimensional rendering engine implemented on top of a graphics library to render objects, user interface components, and advertisement panels. In a typical configuration, the terminal renders product objects in a virtual space and overlays advertisement regions in specified screen coordinates.

The terminal acquires gaze information by controlling the camera and executing an image processing library such as a general-purpose image processing library and a face landmark detection library. The terminal detects a face bounding box, extracts eye regions, and computes pupil center coordinates in the captured image space. The terminal stores calibration parameters that map camera image coordinates to display coordinates. The terminal applies a transformation, for example an affine or projective mapping, to obtain gaze coordinates in the display space. The terminal associates the gaze coordinates with on-screen objects by intersecting the gaze point with precomputed two-dimensional bounding polygons of rendered objects.

The terminal acquires operation information by monitoring input events from the operating system, such as touch events, keypress events, and pointer events. The terminal records, for each event, an event type, a target control or object identifier, and a timestamp. The terminal associates operation events with currently visible items and with advertisement regions. The terminal accumulates browsing history information as a sequence of records including item identifiers, entry times, exit times, and view counts. The terminal stores these records in an internal buffer using a structured data format, for example a table with indexed fields or a time-stamped log.

The terminal acquires face image information and voice information as emotion-related input. The terminal segments video into frames and audio into fixed-length buffers. The terminal applies preprocessing to generate numeric feature tensors. For example, the terminal resizes a cropped face image to a fixed resolution and applies normalization on each color channel, resulting in a tensor of shape (channels, height, width). The terminal applies a short-time Fourier transform to audio, computes mel-scaled filter bank energies, and produces a two-dimensional time-frequency matrix. The terminal groups multiple frames or time slices into a three-dimensional tensor to represent temporal evolution of features.

The server receives these feature tensors, gaze logs, and behavior logs over a communication network using a network protocol such as HTTPS. The server parses the messages, validates formats, and writes them to a database or a feature store. The server uses specific data structures for efficient lookups, for example indexing by user identifier and time interval, and storing gaze data as sequences of (time, x, y, object-id) tuples.

The server executes a user behavior analysis unit as application software running on the CPU. The server loads user behavior data from storage and computes higher-level features. The server aggregates viewing durations per item and per category, computes counts of detail views, counts of add-to-cart operations, and recency measures. The server normalizes these features, for example by applying log-scaling or min-max normalization, to form a behavior feature vector for each (user, category) or (user, item) pair. The server inputs these vectors to a trained prediction model, for example a gradient boosting decision tree model implemented with a numerical library.

The server implements a gradient boosting model by storing a set of decision trees, each with split thresholds and leaf values. The server traverses each tree with the feature vector, computes leaf outputs, and sums them to obtain a raw score. The server converts the raw score into a probability or score by a logistic or other link function. The server assigns the resulting value as an interest degree or purchase intention degree. Because the server uses a structured feature vector and compact tree-based model, the server reduces inference time and memory footprint compared to naïve rule evaluation, improving overall throughput and latency of the advertising system.

The server executes an emotion recognition unit using a deep neural network model on the GPU. In one embodiment, the server uses a convolutional neural network for facial images consisting of multiple convolutional layers, pooling layers, and fully connected layers, trained for multi-class emotion classification. The server uses a recurrent or attention-based network for speech emotion recognition, for example a convolutional front-end followed by a gated recurrent unit or transformer layers that process sequences of mel-spectrogram frames. The server concatenates or fuses the outputs of the facial and speech models by weighted averaging or a small fully connected layer.

The server trains these models offline using a training set containing labeled emotion examples. The server defines a loss function such as cross-entropy between predicted emotion probabilities and ground-truth labels. The server performs backpropagation to compute gradients of the loss with respect to model parameters and updates the parameters by an optimization algorithm such as stochastic gradient descent or an adaptive method. The server optionally applies data augmentation, for example random cropping, horizontal flipping, brightness changes for images, and time-stretching or noise addition for audio, to improve robustness. As a result, the models achieve higher accuracy in classifying subtle emotions from noisy sensor data, which leads to more reliable emotion scores.

The server, during inference, receives the preprocessed feature tensors from the terminal. The server normalizes them according to stored training statistics and forwards the tensors through the networks. The server obtains a probability for each emotion category. The server computes emotion scores as the probabilities or their scaled values. The server stores the scores in a time-indexed structure, enabling queries on emotion trends before, during, and after advertisement display.

The server executes an advertising policy determination unit that takes as input the interest degree, the purchase intention degree, and the emotion scores. The server implements the unit by a rule-based component and optionally by an additional machine learning model. The server evaluates conditions such as “interest degree above threshold1” and “anxiety score above threshold2” to choose an appeal direction such as reassurance. The server also computes an information amount level based on cognitive load indicators; for example, if stress or confusion is high, the server selects a lower information amount. The server chooses an expression tone such as calm or energetic based on a combination of excitement scores and boredom scores. The server can also implement the advertising policy determination unit as a classifier model, such as a small neural network that maps a feature vector comprising behavior scores, emotion scores, and user profile attributes to a discrete policy identifier. The server trains this classifier on historic data where successful policies are labeled. The server uses a loss function such as cross-entropy between predicted and target policies and updates weights using gradient-based optimization. This structured mapping allows the server to compress complex behavior-emotion relationships into a compact model, improving selection consistency and reducing manual rule design.

The server executes an advertising generation unit that constructs a prompt sentence for a generative AI model. The server retrieves attribute information and evaluation information for a target item from a product database. The server then applies a template engine to construct text with placeholders replaced by behavior- and emotion-dependent content. The server inserts explicit constraints into the prompt sentence, including desired tone, information amount, required mention of certain features, and representative user review sentences.

In one example, the server generates the following prompt sentence for a text generative AI model:

“You are a Japanese advertising copywriter. Please create an advertisement text that satisfies the following conditions.
1. The target product is a camping tent ‘Mountain Pro 4-Person Tent’.
2. The user is highly interested in this tent but feels anxious about durability and waterproof performance.
3. In the advertisement, clearly explain the 5000 mm waterproof rating, the high durability provided by reinforced aluminum poles, and the 2-year manufacturer warranty.
4. Use a calm and trustworthy tone with realistic expressions and avoid exaggeration.
5. Incorporate reassuring phrases inspired by real user reviews, such as ‘We slept peacefully even on a very windy night’ and ‘The inside stayed completely dry even during sudden rain’.
6. Keep the length around 200-300 Japanese characters and briefly mention a limited-time free-shipping campaign at the end.”

The server also generates, for an image generative AI model, a prompt sentence such as: “Realistic advertising image for a 4-person mountain tent named ‘Mountain Pro’. Show a family peacefully resting inside the tent during a light rain at night, highlighting the waterproof performance. Use calm, cool colors and a trustworthy, non-flashy design. Include a small badge that says ‘2-year warranty’ in the corner.”

The server sends the prompt sentence to a generative AI model via an inference interface. The generative AI model is implemented as a neural network, for example a transformer-based language model for text and a diffusion or generative adversarial model for images. The server feeds tokenized text into the text model and obtains a sequence of tokens representing advertisement text; the server decodes the tokens into characters or words. The server feeds the image prompt into the image model, which iteratively refines a latent representation by applying denoising steps according to model parameters, generating a pixel array representing an advertisement image.

The server stores generated text and images in storage and associates them with metadata such as policy identifiers and prompt contents. The server optionally executes additional processing on the generated content, such as filtering by a list of prohibited expressions, adjusting the length of text, resizing images, and superimposing logos or legal notices. The server thus converts high-level behavioral and emotional signals into precise, machine-generated advertising content. The server executes an advertising display unit that coordinates with the terminal. The server computes display positions and timings for each advertisement based on policy information and current user context. The server sends control data to the terminal indicating which advertisement to load, where to place it on the screen, and under which conditions to reveal or expand it. The terminal receives this control data and uses local graphics resources to draw advertisement panels. The terminal overlays text on the user interface, binds image textures to 2D or 3D surfaces, and, for video advertisements, invokes a media decoding component to play frames and audio

The terminal monitors gaze information and operation input while the advertisement is displayed. For example, the terminal tracks whether the gaze remains within an advertisement region for more than a threshold duration. If so, the terminal expands the advertisement panel and reveals additional details. The terminal logs operations such as clicks, skips, favorites, and closes, together with timestamps and advertisement identifiers. The terminal transmits these logs back to the server. This interaction allows the system to adjust the interface in real time, reducing unnecessary re-rendering and network requests and thereby lowering communication and computation load.

The server executes a learning update unit that forms a closed feedback loop. The server aligns emotion scores with advertisement display intervals. The server calculates, for each advertisement instance, differences between emotion scores before and after display. The server computes metrics such as anxiety reduction, satisfaction increase, and stress change. The server combines these metrics with operation results and purchase outcomes, forming a learning record that also includes the original prompt sentence, advertising policy parameters, and identifiers for generated content.

The server stores learning records in a structured dataset, for example a relational table or a column-oriented storage optimized for analytics. The server periodically trains or updates models in the advertising policy determination unit and the advertising generation unit. For example, the server trains a regression model to predict expected click-through rate or emotion improvement as a function of policy parameters and prompt features. The server then adjusts thresholds or selects new templates to maximize predicted performance. The server may also train a reinforcement learning agent that treats each policy selection as an action and uses reward signals derived from emotional and behavioral outcomes. In this way, the server improves the internal logic of the system based on feedback, beyond mere manual rule tuning.

The server thereby improves computer technology itself in several respects. First, the server integrates multi-modal signals (gaze, operations, facial expressions, voice) into compact numeric representations that can be processed efficiently by trained models, leading to higher accuracy in estimating user state. Second, the server uses structured advertising policy information to constrain generative AI model behavior through carefully constructed prompt sentences, enabling more targeted and efficient generation of content and reducing the number of iterations or discarded outputs. Third, the server maintains and exploits detailed learning data linking prompts, policies, emotions, and outcomes, enabling machine-led refinement of decision modules and reducing the need for human-engineered heuristics.

Because the server executes optimized inference pipelines for gradient boosting models and neural networks on hardware accelerators, the server achieves reduced latency and increased throughput compared to systems that rely on ad hoc rule sets or unoptimized model serving. Memory-efficient data structures and batched processing of emotion features allow the server to handle many users concurrently while maintaining real-time responsiveness. Moreover, by adjusting advertisement information amount and format according to emotion scores, the server can reduce cognitive overload on the user and prevent excessive retransmissions or repeated ad displays, which indirectly lowers network and storage usage.

Alternative embodiments are also possible. In another embodiment, the terminal performs part of the emotion recognition by executing a compact neural network locally, and the server receives already-aggregated emotion scores instead of raw feature tensors. In another embodiment, the advertising policy determination unit is implemented entirely as a neural network that takes as input concatenated behavior and emotion features, and outputs continuous parameters for appeal direction, tone, and information amount, which are then quantized. In another embodiment, the generative AI model for text is hosted directly on the server and executed on a local GPU cluster, while in another configuration, a remote inference service is accessed. In each case, the server maintains the same logical flow of computing user state, forming advertising policy information, generating prompt sentences, generating advertisement content, and updating models based on measured outcomes.

In further variations, the environment or content presented to the user can be a video stream, a game scene, an augmented reality overlay, or a conventional web page. The server and terminal adapt display positions and interaction handling accordingly, but still use the same fundamental data structures for gaze information, behavior logs, emotion scores, advertising policy information, prompt sentences, and learning data. Thus, a person skilled in the art can implement the invention in various configurations while maintaining the essential technical features and obtaining the technical effects of improved precision, efficiency, and adaptability in computer-controlled advertisement generation and display based on a generative AI model and structured prompt sentences.

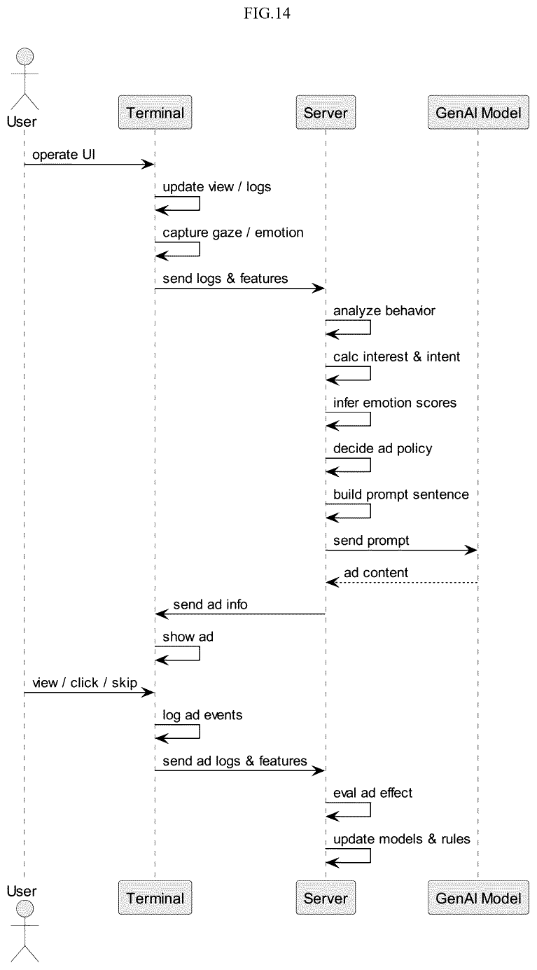

The following describes the processing flow using FIG. 14.

### Step 1:

User operates content on the terminal.

User provides input by touching, clicking, or otherwise manipulating the terminal's input devices to view items, scroll lists, open detail views, and navigate categories or scenes.

Input: Physical user actions (touches, clicks, gestures, key presses).

Output: Low-level input events (event type, coordinates, key code, timestamp) delivered to the terminal OS and application.

### Step 2:

Terminal updates the displayed environment and internal screen state.

Terminal receives the low-level input events and updates the virtual camera position, UI state, and current scene using a graphics engine. Terminal renders a new frame and outputs it to the display. Terminal determines which item identifiers and which interface regions are currently visible.

Input: Input events from Step 1, previous scene state.

Output: Updated frame on the display, and a screen-state record including visible item IDs, active category ID, and timestamp.

### Step 3:

Terminal logs browsing behavior.

Terminal inspects the screen-state record and detects when a new item enters or leaves the visible area. Terminal records a view start time when an item first becomes visible and a view end time when it disappears. Terminal converts these into viewing duration and increments view counts.

Input: Screen-state records from Step 2.

Output: Browsing history records containing item ID, view start time, view end time, and view count.

### Step 4:

Terminal logs operation events related to items and advertisements.

Terminal monitors higher-level UI events generated by the application, such as detail-view button presses, add-to-cart operations, category selections, and advertisement clicks or skips. Terminal associates each event with an item ID or advertisement ID and a timestamp and stores it in a behavior log buffer.

Input: UI events (detail view, add to cart, ad click, ad skip, etc.).

Output: Operation log records including event type, target ID (item or ad), timestamp, and context (current scene or category).

### Step 5:

Terminal acquires gaze information.

Terminal controls the camera to capture image frames and uses an image processing library to detect a face and eye regions. Terminal calculates pupil center coordinates in image space and transforms them into display-space gaze coordinates using calibration parameters. Terminal determines which object's on-screen bounding region contains the gaze point at each timestamp. Input: Raw camera frames, calibration parameters, object bounding regions.

Output: Gaze information records containing timestamp, gaze coordinates, and associated item or advertisement ID.

### Step 6:

Terminal preprocesses emotion-related features.

Terminal segments camera frames and microphone audio into fixed-length windows. Terminal crops and resizes face regions and normalizes pixel values to produce image tensors. Terminal computes mel-spectrograms from audio segments to produce audio feature tensors. Terminal groups sequences of image and audio feature tensors for each time window and links them with the current user ID and context.

Input: Raw video frames and audio samples, current user context.

Output: Batched emotion feature tensors (image and audio) with associated user ID and time window metadata.

### Step 7:

Terminal packages and transmits behavior, gaze, and emotion data.

Terminal reads browsing history records, operation logs, gaze information, and emotion feature batches from internal buffers. Terminal serializes these data structures into a compact format, such as JSON or binary, using a serialization library. Terminal establishes an HTTPS connection to the server and transmits the serialized payloads.

Input: Behavior logs, gaze records, emotion feature batches.

Output: Serialized data packets sent to the server over the network.

### Step 8:

Server receives and stores raw data.

Server, via a web framework, accepts HTTPS requests, decodes the serialized payloads, and validates data fields. Server writes behavior logs and gaze records into a database, indexing them by user ID and time. Server stores emotion feature tensors in a feature store with references to user IDs and timestamps.

Input: Serialized data packets from Step 7.

Output: Persisted records in databases and feature stores ready for analysis.

### Step 9:

Server computes behavior-based features.

Server queries the database for recent behavior logs and gaze data for a specific user. Server aggregates viewing durations, view counts, detail-view counts, add-to-cart counts, and recency measures per item or category. Server converts these aggregate values into normalized numeric vectors representing user behavior.

Input: Behavior logs and gaze records from Step 8.

Output: Behavior feature vectors per (user, item) or (user, category).

### Step 10:

Server calculates interest and purchase intention degrees.

Server loads a pre-trained prediction model, such as a gradient boosting tree model, and applies it to each behavior feature vector. Server traverses the trees with feature values, sums leaf outputs, and applies a logistic or other activation function to compute probability-like scores. Server stores these scores as interest degrees and purchase intention degrees.

Input: Behavior feature vectors from Step 9, model parameters for the prediction model. Output: Interest degree and purchase intention degree records per user and item/category.

### Step 11:

Server estimates emotion scores from feature tensors.

Server loads pre-trained deep neural networks for facial and speech emotion recognition. Server normalizes incoming image and audio feature tensors and forwards them through the networks on a GPU. Server obtains, for each time window, a probability distribution over emotion classes from each network and combines them, for example by weighted averaging or a small fusion layer, to produce final emotion score vectors.

Input: Emotion feature tensors from Step 8, model parameters of facial and speech emotion networks.

Output: Emotion score records per user and time window, each containing scores for multiple emotion categories.

### Step 12:

Server determines advertising policy information.

Server gathers the latest interest degrees, purchase intention degrees, and emotion scores for the user and current item or category. Server inputs these values into an advertising policy determination module, which may use rule-based logic or a trained classifier to select an appeal direction, information amount, expression tone, display timing, and display format. Server constructs a structured policy record representing these decisions.

Input: Interest degrees and purchase intention degrees from Step 10, emotion scores from Step 11.

Output: Advertising policy information specifying parameters for the next advertisement.

### Step 13:

Server retrieves item metadata and evaluation data.

Server queries a product database for attribute information of the target item, such as category, specifications, price, and warranty. Server also queries review tables or evaluation records for ratings and representative user comments. Server combines these values into a structured item profile.

Input: Item or category identifiers and user context from Step 12.

Output: Item attribute information and evaluation information suitable for inclusion in a prompt.

### Step 14:

Server generates a prompt sentence for a generative AI model.

Server selects a prompt template based on the advertising policy information, for example a reassurance-focused or excitement-focused template. Server uses a template engine to insert attribute information, evaluation phrases, and explicit constraints (tone, information amount, key points) into the template. Server produces a complete natural-language prompt sentence describing the desired advertisement.

Input: Advertising policy information from Step 12, item attribute and evaluation information from Step 13.

Output: A prompt sentence text string configured for input to a generative AI model.

### Step 15:

Server generates advertisement content using the generative AI model.

Server sends the prompt sentence to a text generative AI model, such as a transformer language model, via an API. Server receives generated tokens, decodes them into text, and applies post-processing such as filtering, length normalization, and formatting. If an image advertisement is needed, server sends an image-oriented prompt sentence to an image generative AI model, such as a diffusion-based model, and receives an image. Server may perform image resizing, compositing, and annotation.

Input: Prompt sentence from Step 14, model parameters for text and/or image generative AI models.

Output: Generated advertisement content, including text advertisement, image advertisement, or both.

### Step 16:

Server stores generated advertisements and prepares display control data.

Server writes generated advertisement files to storage and registers them in the database with unique identifiers and associated policy and prompt metadata. Server determines a display position and timing according to the advertising policy and current user context and forms a control message containing advertisement IDs, resource URLs, and display conditions. Input: Generated advertisements from Step 15, advertising policy information from Step 12, current user context.

Output: Stored advertisement resources and display control data ready to be sent to the terminal.

### Step 17:

Server transmits advertisement control information to the terminal.

Server sends a response or push message to the terminal that includes advertisement identifiers, content URLs, and instructions specifying where, when, and how to display the advertisements.

Input: Display control data from Step 16.

Output: Network message to the terminal containing advertisement display instructions.

### Step 18:

Terminal downloads and renders advertisement content.

Terminal receives the control message and parses it to obtain advertisement URLs and display parameters. Terminal downloads text and media resources from the server or storage service. Terminal loads the image or video into the graphics or media framework and overlays advertisement panels at specified positions within the content display region.

Input: Advertisement display instructions from Step 17, advertisement resources from server storage.

Output: Displayed advertisements integrated into the user's current content view.

### Step 19:

Terminal monitors user gaze and interactions with advertisements.

Terminal continues to track gaze using camera frames and updates gaze coordinates as before. Terminal checks whether the user's gaze remains within an advertisement region for more than a threshold duration and, if so, expands the advertisement or shows additional detail. Terminal also listens for interaction events such as clicks, taps, skips, closes, and favorites involving advertisement components and converts them into interaction logs.

Input: Updated camera frames, input events while advertisements are visible, advertisement region definitions.

Output: Gaze records specific to advertisements and advertisement interaction logs (click, skip, close, favorite, etc.).

### Step 20:

Terminal sends advertisement interaction and emotion-related data to the server.

Terminal associates advertisement interaction logs and gaze records with advertisement IDs and timestamps. Terminal also collects emotion feature tensors for time windows around advertisement display periods. Terminal serializes these data structures and transmits them to the server via HTTPS.

Input: Advertisement interaction logs and gaze records from Step 19, emotion feature tensors for advertisement intervals.

Output: Serialized data packets containing advertisement-related behavior and emotion data sent to the server.

### Step 21:

Server evaluates advertisement effects on emotion and behavior.

Server receives the advertisement-related logs and emotion features and stores them in the appropriate databases. Server recomputes or looks up emotion scores for the pre-ad and post-ad windows. Server calculates differences in key emotion scores, such as anxiety or satisfaction. Server aggregates these differences with interaction outcomes such as click, skip, or purchase, forming detailed effectiveness metrics for each advertisement instance.

Input: Advertisement logs and emotion feature tensors from Step 20, emotion models from Step 11.

Output: Advertisement effectiveness records containing emotional changes, interaction outcomes, and associated advertisement identifiers.

### Step 22:

Server constructs learning data linking prompts, policies, and outcomes.

Server retrieves the prompt sentence, advertising policy information, and generated content metadata used for each advertisement instance. Server links these with the effectiveness records and assembles comprehensive learning data entries. Each entry captures the mapping from input state and policy to generative prompt, resulting advertisement, and measured outcomes. Input: Effectiveness records from Step 21, stored prompts and policy records from Steps 12-16.

Output: Structured learning data entries stored in a learning database.

### Step 23:

Server updates models and rules using learning data.

Server periodically loads the learning data and trains or updates models used in the advertising policy determination unit and advertising generation unit. Server may fit regression or classification models predicting performance given policy settings and prompt features, or adjust rule thresholds based on observed results. After training, server updates model parameters and internal configuration to modify future policy selection and prompt construction behavior. Input: Learning data from Step 22, training algorithms and model structures.

Output: Updated model parameters and configuration values, resulting in refined policy and prompt generation behavior for subsequent advertising cycles.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

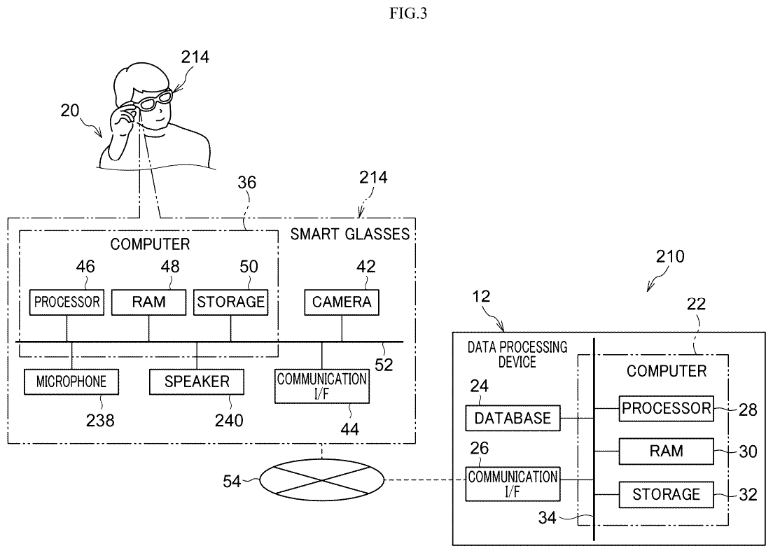

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

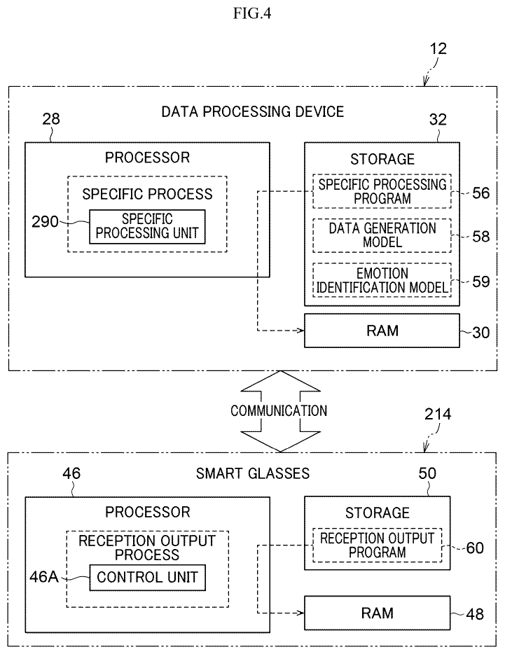

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

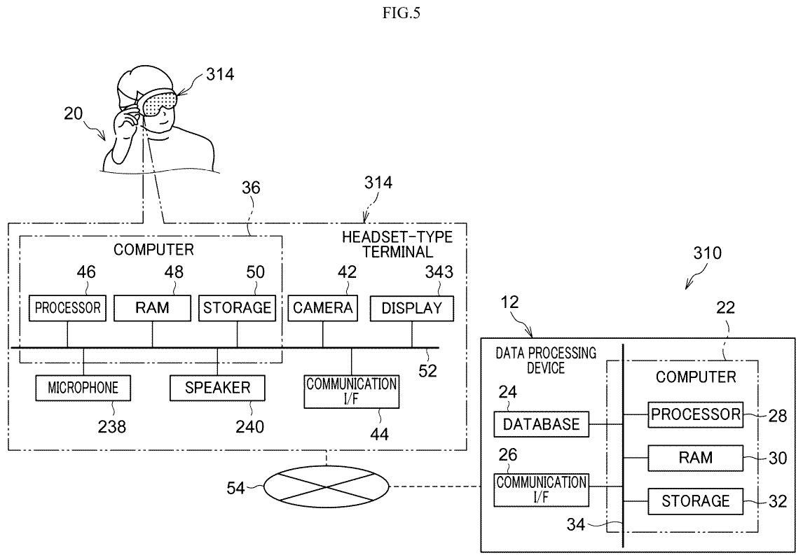

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

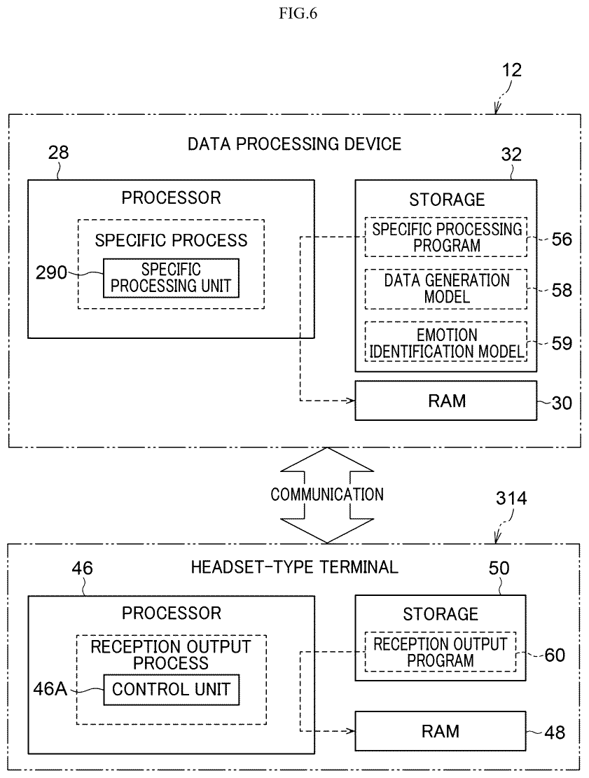

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

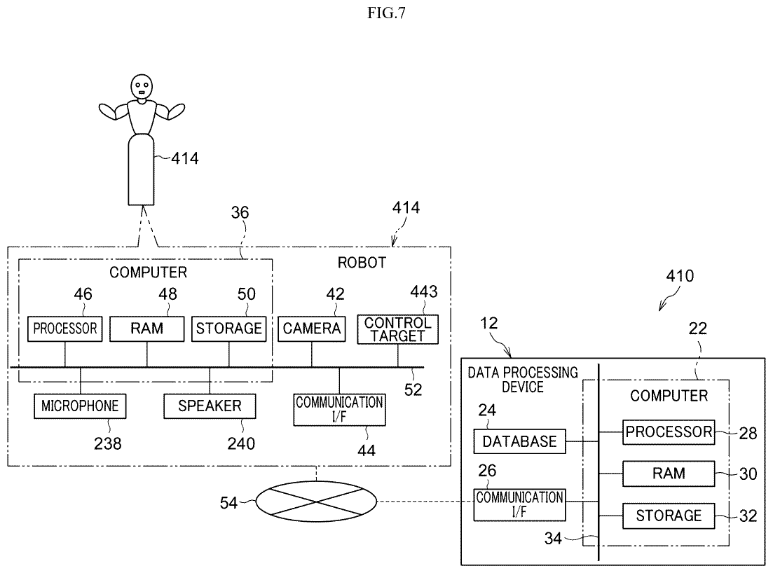

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

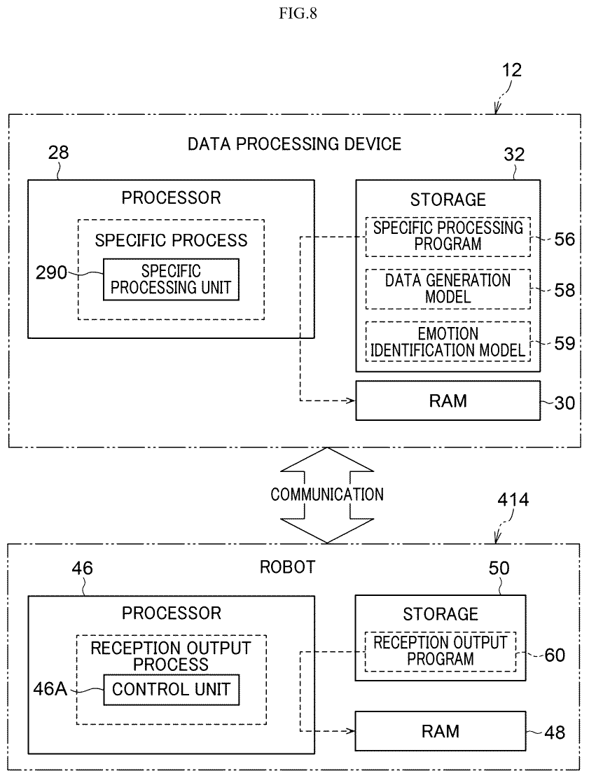

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot

414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

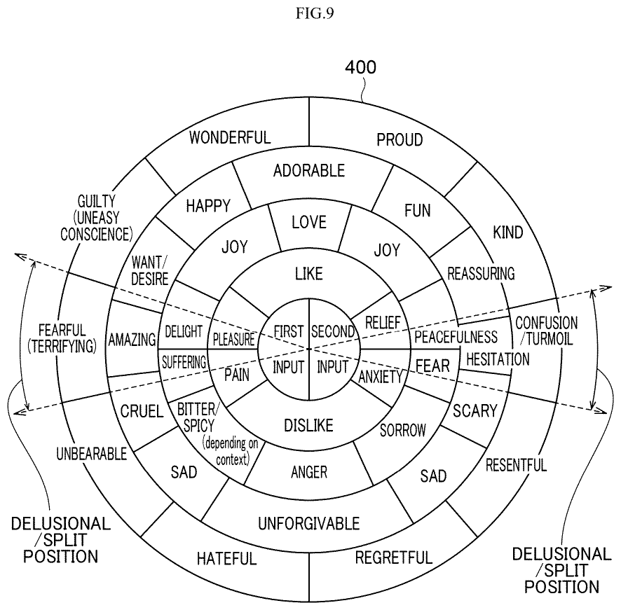

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

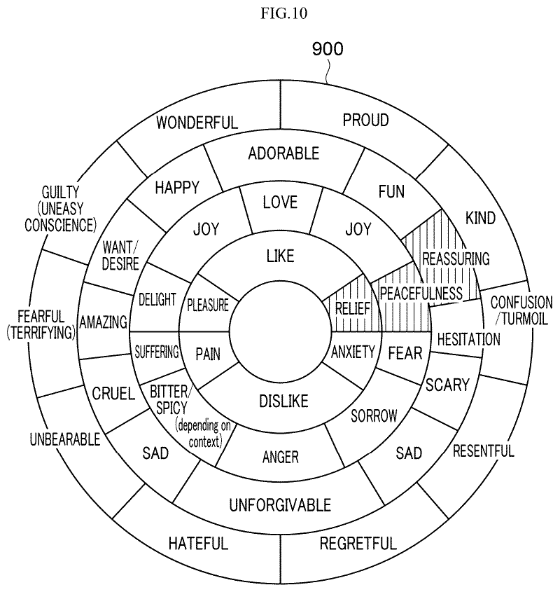

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, wherein the processor is configured to analyze viewing information including video information and audio information in a time-series manner, identify image features, acoustic features, scene boundaries, objects, subjects, background environments, color distributions, motion amounts, conversation contents, music information, and sound effect information, determine a scene and a time suitable for inserting an advertisement based on the identified features, detect, within the viewing information, advertisement placement candidate regions including signboards, display surfaces, posting surfaces, and display devices, and generate scene description information for each scene, the scene description information including at least a scene type, an emotional state, a main topic, and the advertisement placement candidate regions; and acquire, based on user identification information, user history information including viewing history information, advertisement viewing history information, operation history information, and preference information, select an advertisement type and an advertisement concept by executing a recommendation process that uses, as input, scene feature information included in the scene description information and user feature information included in the user history information, generate, in a natural language, a prompt sentence corresponding to the scene description information, the user feature information, and the advertisement concept, input the prompt sentence to a generative information processing model to generate advertisement materials including advertisement character information, advertisement image information, and advertisement audio information, and convert and normalize the generated advertisement materials so as to satisfy predetermined conditions relating to length, resolution, format, and content; and create, based on the scene description information and the advertisement materials, advertisement placement planning information that specifies a temporal position and a spatial position in the viewing information for placement of each advertisement material, generate embedding control information including, for each advertisement material, at least a start time, an end time, a display position, a display region, a display order, and mixing conditions, transmit the embedding control information to a terminal device, and cause the terminal device to execute image composition processing and audio mixing processing such that the advertisement materials are superimposed on the advertisement placement candidate regions in synchronization with reproduction of the viewing information; and collect user behavior information transmitted from the terminal device, the user behavior information including advertisement viewing time, advertisement skip operations, advertisement selection operations, evaluation operations, and other user actions, store the user behavior information in association with the prompt sentence, the advertisement materials, and the advertisement placement planning information, and update generation rules of the prompt sentence, selection conditions of the advertisement concept, and generation conditions of the advertisement placement planning information based on the user behavior information so as to dynamically optimize advertisement materials to be generated thereafter and an advertisement embedding method.

### (Supplementary 2)

The system according to supplementary 1, wherein the processor is configured to adjust, as the updating of the generation rules of the prompt sentence, description contents relating to advertisement length, expression style, emotional expression, information amount, and intrusiveness based on the user behavior information, and change configuration elements, word selection, and constraint conditions of the prompt sentence to be input to the generative information processing model, so that different advertisement expressions are generated for each user or each user group.

### (Supplementary 3)

The system according to supplementary 1, wherein the processor is configured to cause the generative information processing model to include a language model that generates the advertisement character information and at least one of an image generation model and a video generation model that generates advertisement image information or video information, and to provide, as a part of the prompt sentence, scene type information, emotional state information, user preference information, and advertisement placement candidate region information as common condition information to the language model and the at least one of the image generation model and the video generation model, such that the advertisement character information, the advertisement image information, and the advertisement audio information obtained from the models are generated and combined as advertisement materials consistent with one another.

### Application Example 1

### (Supplementary 1)

A system comprising a processor,
wherein the processor is configured to
analyze information content by using an analysis unit that processes at least one of visual data, audio data, or interaction data to obtain analysis results,
generate, on the basis of the analysis results and user behavior information, a prompt sentence to be input to a generative AI model, and generate advertisement information by using the generative AI model in accordance with the prompt sentence,
embed or place the generated advertisement information naturally into at least one of a virtual space or a time-series information content by using an embedding unit that adjusts at least one of a layout, a visual appearance, or an audio parameter of the advertisement information, acquire user behavior information by using an acquisition unit that obtains at least gaze information, operation information, and browsing-history information of a user, and provide the user behavior information to at least one of the analysis unit or a generation unit that includes the generative AI model, and
optimize, by using an optimization unit, at least one of the prompt sentence or generation conditions of the advertisement information on the basis of an evaluation result obtained from at least one of a user attention state, an advertisement viewing time, or an operation history with respect to the embedded or placed advertisement information.

### (Supplementary 2)

The system according to supplementary 1, wherein the processor is configured to
aggregate, by the analysis unit, at least one of stay-time information, gaze-tracking information, or selection-operation information with respect to item information or display-target information arranged in the virtual space, on a per-user and per-session basis, estimate interest-field information of the user from the aggregated information, and dynamically place the advertisement information by the embedding unit in at least one of a predetermined region in a field of view of the user or a vicinity of related display-target information in the virtual space, on the basis of the interest-field information and at least one of position information or gaze-direction information of the user in the virtual space.

### (Supplementary 3)

The system according to supplementary 1,
wherein the processor is configured to
control input and output conditions of the generative AI model such that a writing style, an amount of explanation, and appeal elements of the prompt sentence are changed in accordance with at least one of advertisement viewing-time information, skip-rate information, or preferred-style information obtained by the optimization unit, and such that different advertisement expression modes are generated for respective users.

### Example 2

### (Supplementary 1)

A system comprising a processor,
wherein the processor is configured to
analyze, from video information and audio information included in an audiovisual medium, the audiovisual medium on a time-unit basis, divide the audiovisual medium into a plurality of scenes, and, for each of the plurality of scenes, acquire analysis metadata including a scene section, a scene type, an appearance subject, a background type, a motion feature, and an acoustic feature, estimate an emotional atmosphere of each scene based on the audio information and the acoustic feature, and add the emotional atmosphere as part of the analysis metadata, acquire, via a communication apparatus, imaging information, acoustic information, and operation history information transmitted from a terminal apparatus, estimate a temporal transition of an emotional state of a user of the terminal apparatus based on the imaging information, the acoustic information, and the operation history information, and, based on the analysis metadata, the emotional state, and viewing history information, automatically generate, in a natural language, a prompt sentence that is an instruction sentence to be input to a generative AI model, input the prompt sentence to the generative AI model to generate advertisement content including advertisement text information and advertisement image information, and generate advertisement audio information by performing speech synthesis processing based on a result of generation of the advertisement content,
determine, based on object-region information and background-region information included in the analysis metadata and dimension information of the advertisement image information, an advertisement embedding region, a display position, a display size, and a display time band within each of the plurality of scenes of the audiovisual medium, generate display control information for superimposing the advertisement image information on the advertisement embedding region by projection transformation and composition processing, and generate audio control information including a start time, a volume coefficient, and a fade time for mixing the audio information of the audiovisual medium and the advertisement audio information, and provide the display control information and the audio control information to the terminal apparatus so that the terminal apparatus naturally embeds and presents the advertisement content in accordance with scene content of the audiovisual medium and the emotional state of the user of the terminal apparatus, and
collect, from the terminal apparatus, feedback information including at least one of a viewing completion rate, a skip operation, a selection operation, an evaluation input, and emotional-state information during a period in which the advertisement content is presented, and, based on the feedback information and the emotional-state information, perform learning-based updating of at least one of a generation rule of the prompt sentence and a parameter of the generative AI model so as to continuously optimize generation content of the advertisement content and embedding control of the advertisement content.

### (Supplementary 2)

The system according to supplementary 1,
wherein the processor is configured to
control the terminal apparatus to execute, within the terminal apparatus, expression recognition processing and speech-emotion recognition processing on a face-region image acquired from an imaging device and on an audio signal acquired from an acoustic acquisition device during reproduction of the audiovisual medium, by using an inference processing engine in the terminal apparatus, thereby acquiring emotion-estimation scores, and to cause the terminal apparatus to integrate the emotion-estimation scores with an operation history related to reproduction control of the audiovisual medium, calculate a comprehensive emotional state of the user of the terminal apparatus, transmit emotional-state information in which the comprehensive emotional state is associated with time information of the audiovisual medium to the processor, and, based on the display control information and the audio control information received from the processor, superimpose the advertisement image information on a predetermined object region or background region of the audiovisual medium by perspective transformation and display the superimposed image on a display device, and mix and output the advertisement audio information with the audio information of the audiovisual medium from an acoustic output device.

### (Supplementary 3)

The system according to supplementary 1,
wherein the processor is configured to
construct the prompt sentence by using a prompt template including attribute information specifying at least a scene type, the emotional atmosphere of the scene, a current emotional state of the user of the terminal apparatus, and a preference category of the user of the terminal apparatus, and further specifying an advertisement-target item category and an output-format constraint, and to input, as parameters to the generative AI model, at least a scene description, tone instructions, style instructions, and output-structure instructions contained in the prompt sentence, thereby dynamically generating advertisement content adapted to the scene type and the emotional state.

### Application Example 2

### (Supplementary 1)

A system comprising a processor,
wherein the processor is configured to function as a user behavior analysis unit that acquires gaze information, position information, operation information, and browsing history information from a terminal used by a user, and calculates, based on the gaze information, the position information, the operation information, and the browsing history information, an interest degree for each attribute category of a target item and a purchase intention degree for the target item, wherein the processor is configured to function as an emotion recognition unit that acquires face image information and voice information from the terminal and applies a machine learning model to the face image information and the voice information to calculate emotion scores corresponding to a plurality of types of emotions of the user,
wherein the processor is configured to function as an advertising policy determination unit that determines advertising policy information including an appeal direction, an information amount, an expression tone, a display timing, and a display format of an advertisement, based on the interest degree, the purchase intention degree, and the emotion scores, wherein the processor is configured to function as an advertising generation unit that, based on the advertising policy information and on attribute information and evaluation information of the target item, automatically generates a prompt sentence to be input to a generative AI model, inputs the prompt sentence to the generative AI model, and generates at least one of a text advertisement, an image advertisement, and a video advertisement,
wherein the processor is configured to function as an advertising display unit that causes the text advertisement, the image advertisement, or the video advertisement to be superimposed and displayed at a predetermined position and at a predetermined timing within a display region of a provided environment or content, and that controls a display mode of the advertisement or an expansion of detailed information of the advertisement in accordance with a gaze position and an operation input of the user during display of the advertisement, and
wherein the processor is configured to function as a learning update unit that acquires a change in the emotion scores before and after the display of the advertisement and an operation result of the user with respect to the advertisement, stores, as learning data, a correspondence among the prompt sentence, the advertising policy information, the change in the emotion scores, and the operation result, and updates processing contents of the advertising policy determination unit and the advertising generation unit based on the learning data.

### (Supplementary 2)

The system according to supplementary 1,
wherein the processor is configured to cause the advertising policy determination unit to further analyze, in addition to the interest degree and the purchase intention degree calculated by the user behavior analysis unit and the emotion scores calculated by the emotion recognition unit, history information including viewing history of content, viewing time of advertisements, skip rate of advertisements, operation history, and purchase history of the user, and to update the advertising policy information over time based on an analysis result of the history information so as to automatically optimize, for each user, the appeal direction, the information amount, and the display timing of the advertisement.

### (Supplementary 3)

The system according to supplementary 1,
wherein the processor is configured to cause the advertising generation unit to use, as the generative AI model, a model that has been trained in advance using a plurality of advertising contents and associated metadata, to generate, based on the advertising policy information and the prompt sentence, advertising content in a plurality of formats including visual elements and auditory elements, and to customize a style, content, and tone of the advertising content in accordance with an interest state and an emotion state of the user obtained from the user behavior analysis unit and the emotion recognition unit.

What is claimed is:

1. A system comprising:
circuitry configured to:
receive, via a communication interface coupled to a packet-switched network, a data stream comprising time-series video frames and an associated audio signal;
analyze the time-series video frames and the associated audio signal to identify scene boundaries, scene types, emotional-state indicators, topic indicators, and object regions within the data stream, and generate scene description information for each identified scene;
generate a natural-language prompt sentence based on the scene description information and user feature information derived from stored interaction history, input the natural-language prompt sentence to a generative neural network model, and obtain output data comprising text information, image information, and audio information;
compute embedding control information specifying, for each element of the output data, a temporal position, a spatial position, a display region, a layer order, and audio mixing parameters within the data stream, and transmit the output data and the embedding control information to a terminal device via the communication interface so that the terminal device performs image composition processing and audio mixing processing in synchronization with reproduction of the data stream; and
receive, from the terminal device via the communication interface, user behavior data associated with the output data, and update at least one of generation rules for the natural-language prompt sentence and parameters for computing the embedding control information based on the user behavior data.

2. The system according to claim 1, wherein the circuitry is configured to apply a convolutional neural network to each of the time-series video frames to extract image feature vectors comprising color distributions, edge descriptors, and texture descriptors, and to apply an optical-flow estimation algorithm between consecutive frames to compute motion vectors and a motion magnitude distribution.

3. The system according to claim 2, wherein the circuitry is configured to detect the scene boundaries by comparing the image feature vectors and the motion magnitude distribution across successive frames and determining that a scene boundary exists when a difference exceeds a threshold, and to apply an object detection model to frames within each detected scene to identify bounding boxes, class labels, and confidence scores for candidate placement regions comprising signboards, display surfaces, posting surfaces, and display devices.

4. The system according to claim 3, wherein the circuitry is configured to apply a transformer-based automatic speech recognition model to a segment of the associated audio signal corresponding to each detected scene to generate a time-stamped transcript, apply a topic classification model to the time-stamped transcript to output the topic indicators, and apply a sentiment analysis model to the time-stamped transcript to output the emotional-state indicators.

5. The system according to claim 4, wherein the circuitry is configured to aggregate, for each detected scene, the image feature vectors, the motion vectors, the topic indicators, the emotional-state indicators, the bounding boxes, and temporal boundary information into a structured scene description record stored in a database, the structured scene description record comprising a scene identifier, a scene type label, an emotional-state label, a main topic label, a list of detected objects, a list of candidate placement regions with coordinates and region types, and start and end timestamps.

6. The system according to claim 1, wherein the circuitry is configured to acquire the user feature information by retrieving, from a user data store using user identification information received from the terminal device, viewing history information, interaction history information, operation history information, and preference information, and transforming the retrieved information into a numerical user feature vector.

7. The system according to claim 6, wherein the circuitry is configured to execute a recommendation process by inputting a concatenation of scene feature information derived from the scene description information and the numerical user feature vector to a ranking model, the ranking model computing a selection score for each of a plurality of content categories, and selecting a content category having a highest selection score.

8. The system according to claim 7, wherein the circuitry is configured to construct the natural-language prompt sentence by selecting a prompt template from a plurality of stored prompt templates based on the scene type and the selected content category, and filling placeholders in the selected prompt template with the scene type, the emotional-state indicator, the topic indicator, user preference indicators from the numerical user feature vector, and a description of the selected content category.

9. The system according to claim 8, wherein the generative neural network model comprises a transformer-based language model that receives the natural-language prompt sentence as a token sequence and outputs the text information, and a diffusion-based image generation model that receives the natural-language prompt sentence as a conditioning input and iteratively refines a latent representation through denoising steps to produce the image information.

10. The system according to claim 9, wherein the circuitry is configured to generate the audio information by applying a text-to-speech model comprising a neural vocoder to at least a portion of the text information, and adjusting prosody parameters comprising speaking rate, pitch, and energy based on the emotional-state indicator associated with a corresponding scene.

11. The system according to claim 1, wherein the circuitry is configured to normalize the output data by converting image resolutions and aspect ratios to predetermined display dimensions, encoding the image information into a compressed image format, encoding the audio information into a compressed audio format, and limiting a duration of the audio information to a maximum value.

12. The system according to claim 11, wherein the circuitry is configured to compute the embedding control information by selecting, from a plurality of candidate placement regions identified in the scene description information, a placement region having a highest score according to a scoring function that evaluates region size, visibility, and absence of occluding objects, and computing a projection transformation matrix that maps the image information onto the selected placement region.

13. The system according to claim 12, wherein the audio mixing parameters comprise a volume coefficient for the audio information of the output data, a volume coefficient for the associated audio signal of the data stream, and fade-in and fade-out durations, and wherein the circuitry is configured to select a start time for the audio information during a segment of the associated audio signal determined to be a non-speech interval based on a speech-activity classifier.

14. The system according to claim 13, wherein the circuitry is configured to transmit the output data and the embedding control information to the terminal device so that the terminal device creates a texture from the image information using a graphics processing unit, applies the projection transformation matrix to render the texture in perspective alignment with the selected placement region, and blends the texture with an underlying frame of the data stream using an alpha transparency value specified in the embedding control information.

15. The system according to claim 1, wherein the user behavior data comprises a viewing duration for each element of the output data, a count of skip operations, a count of selection operations, and evaluation indicators, each associated with an element identifier and a scene identifier.

16. The system according to claim 15, wherein the circuitry is configured to compute, from the user behavior data, aggregate performance metrics comprising a skip rate per prompt template, a selection rate per content category, and a completion rate per placement pattern, and to update the generation rules for the natural-language prompt sentence by modifying elements of prompt templates comprising target duration, expression style, and information density based on the aggregate performance metrics.

17. The system according to claim 16, wherein the circuitry is configured to retrain or fine-tune the ranking model by defining a loss function over training samples comprising scene feature information, user feature information, and labels derived from the user behavior data, and updating weights of the ranking model using gradient-based optimization.

18. A system comprising:
circuitry configured to:
receive, via a communication interface coupled to a packet-switched network, a data stream comprising time-series video frames encoded in a compressed video format and an associated audio signal encoded in a compressed audio format;
decode the compressed video format to obtain a sequence of raw frames at a normalized resolution and decode the compressed audio format to obtain an audio waveform at a standardized sampling rate;
apply a convolutional neural network to each raw frame to compute image feature maps, apply an optical-flow estimation algorithm between consecutive raw frames to compute motion vectors and a motion magnitude distribution, detect scene boundaries based on changes in the image feature maps and the motion magnitude distribution, and apply an object detection model to identify bounding boxes and class labels for candidate placement regions within each detected scene;
apply a transformer-based automatic speech recognition model to segments of the audio waveform to generate time-stamped transcripts, apply a topic classification model to each transcript segment to output topic labels, and apply a sentiment analysis model to each transcript segment to output emotional-state labels, and aggregate the image feature maps, the motion vectors, the topic labels, the emotional-state labels, the bounding boxes, and temporal boundary information into scene description information stored as structured records;
generate a natural-language prompt sentence by selecting a prompt template and filling placeholders with the scene type, the emotional-state label, the topic label, user feature information derived from stored interaction history, and a content category selected by a recommendation model, input the natural-language prompt sentence to a transformer-based language model to generate text information, input the natural-language prompt sentence to a diffusion-based image generation model to generate image information, and apply a text-to-speech model to at least a portion of the text information to generate audio information;
normalize the text information, the image information, and the audio information to conform to predetermined resolution, format, and duration constraints, select a candidate placement region based on a scoring function, compute a projection transformation matrix mapping the image information onto the selected candidate placement region, and compute audio mixing parameters comprising a volume coefficient, a fade-in duration, and a fade-out duration;
transmit the normalized image information, the audio information, the projection transformation matrix, and the audio mixing parameters to a terminal device via the communication interface so that the terminal device renders the image information as a texture in perspective alignment with the selected candidate placement region and mixes the audio information with the associated audio signal in synchronization with reproduction of the data stream; and
receive, from the terminal device via the communication interface, user behavior data comprising viewing duration metrics, skip-operation counts, and selection-operation counts, compute aggregate performance metrics from the user behavior data, and update at least one of the prompt template, weights of the recommendation model, and the scoring function based on the aggregate performance metrics.

19. The system according to claim 18, wherein the circuitry is configured to receive, from the terminal device, emotional-state information estimated by the terminal device based on imaging information captured by an imaging device of the terminal device and acoustic information captured by an acoustic acquisition device of the terminal device, and to incorporate the emotional-state information into the generation of the natural-language prompt sentence such that the prompt template further encodes a current emotional state of a user of the terminal device.

20. A method performed by circuitry, the method comprising:
receiving, via a communication interface coupled to a packet-switched network, a data stream comprising time-series video frames and an associated audio signal;
analyzing the time-series video frames and the associated audio signal to identify scene boundaries, scene types, emotional-state indicators, topic indicators, and object regions within the data stream, and generating scene description information for each identified scene;
generating a natural-language prompt sentence based on the scene description information and user feature information derived from stored interaction history, inputting the natural-language prompt sentence to a generative neural network model, and obtaining output data comprising text information, image information, and audio information;
computing embedding control information specifying, for each element of the output data, a temporal position, a spatial position, a display region, a layer order, and audio mixing parameters within the data stream, and transmitting the output data and the embedding control information to a terminal device via the communication interface so that the terminal device performs image composition processing and audio mixing processing in synchronization with reproduction of the data stream; and
receiving, from the terminal device via the communication interface, user behavior data associated with the output data, and updating at least one of generation rules for the natural-language prompt sentence and parameters for computing the embedding control information based on the user behavior data.
